(19) United States
(12) Patent Application Publication
(10) Pub. No.: US 2025/0038817 A1
(43) Pub. Date: Jan. 30, 2025

(54) SENSING PROCESSING METHOD AND APPARATUS, NETWORK-SIDE DEVICE, AND TERMINAL

(71) Applicant: VIVO MOBILE COMMUNICATION CO., LTD., Dongguan (CN)

(72) Inventors: Jianzhi LI, Dongguan (CN); Dajie JIANG, Dongguan (CN); Jianming WU, Dongguan (CN); Shengli DING, Dongguan (CN)

(73) Assignee: VIVO MOBILE COMMUNICATION CO., LTD., Dongguan (CN)

(21) Appl. No.: 18/914,355

(22) Filed: Oct. 14, 2024

Related U.S. Application Data
(63) Continuation of application No. PCT/CN2023/088028, filed on Apr. 13, 2023.

(30) Foreign Application Priority Data
Apr. 15, 2022 (CN) 202210399400.9

(51) Int. Cl. H04B 7/06

(52) U.S. Cl. CPC H04B 7/0691

(57) ABSTRACT

This application discloses a sensing processing method and apparatus, a network-side device, and a terminal. The sensing processing method includes: when target information changes, determining, by a first device, target antenna selection information of a target sensing device based on the target information; and sending, by the first device, the target antenna selection information The target sensing device includes at least one of a sending device for sending a first signal or a receiving device for receiving the first signal, and the target antenna selection information is used for the target sensing device to perform an antenna selection for the first signal.

### CROSS-REFERENCE TO RELATED APPLICATIONS

This application of International Application No. PCT/CN2023/088028, filed on Apr. 13, 2023, which claims priority to Chinese Patent Application No. 202210399400.9, filed on Apr. 15, 2022. The entire contents of each of the above-referenced applications are expressly incorporated herein by reference.

### TECHNICAL FIELD

This application pertains to the field of communication technologies, and in particular to a sensing processing method and apparatus, a network-side device, and a terminal.

### BACKGROUND

With development of communication technologies, integrated sensing and communication can be implemented in a communication system. In an integrated sensing and communication scenario, there are two types of services, communication and sensing. Currently, in a conventional sensing method, a fixed antenna is usually used to perform a sensing service or an integrated sensing and communication service. Because a status of a sensing target or a sensing environment constantly changes, if the fixed antenna is used to perform the sensing service or the integrated sensing and communication service, sensing performance may be degraded.

### SUMMARY

Embodiments of this application provide a sensing processing method and apparatus, a network-side device, and a terminal to improve sensing performance.

According to a first aspect, a sensing processing method is provided and includes:
in a case that target information changes, determining, by a first device, target antenna selection information of a target sensing device based on the target information; and
sending, by the first device, the target antenna selection information, where
the target sensing device includes at least one of a sending device for sending a first signal and a receiving device for receiving the first signal, and the target antenna selection information is used for the target sensing device to perform an antenna selection for the first signal.

According to a second aspect, a sensing processing method is provided and includes:
receiving, by a first sensing device, target antenna selection information from a first device; and
performing, by the first sensing device, an antenna selection operation based on the target antenna selection information, where an antenna selected by the antenna selection operation is used to send or receive a first signal.

According to a third aspect, a sensing processing apparatus is provided and includes:
a first determining module, configured to determine target antenna selection information of a target sensing device based on target information in a case that the target information changes; and
a first sending module, configured to send the target antenna selection information, where
the target sensing device includes at least one of a sending device for sending a first signal and a receiving device for receiving the first signal, and the target antenna selection information is used for the target sensing device to perform an antenna selection for the first signal.

According to a fourth aspect, a sensing processing apparatus is provided and applied to a first sensing device and includes:
a second receiving module, configured to receive target antenna selection information from a first device; and
a selection module, configured to perform an antenna selection operation based on the target antenna selection information, where an antenna selected by the antenna selection operation is used to send or receive a first signal.

According to a fifth aspect, a first sensing device is provided. The first sensing device includes a processor and a memory. The memory stores a program or instructions capable of running on the processor. When the program or instructions are executed by the processor, the steps of the method according to the first aspect are implemented.

According to a sixth aspect, a terminal is provided and includes a processor and a communication interface. The communication interface is configured to receive target antenna selection information from a first device; and the processor is configured to perform an antenna selection operation based on the target antenna selection information, where an antenna selected by the antenna selection operation is used to send or receive a first signal.

According to a seventh aspect, a network-side device is provided. The network-side device includes a processor and a memory. The memory stores a program or instructions capable of running on the processor. When the program or instructions are executed by the processor, the steps of the method according to the first aspect are implemented, or the steps of the method according to the second aspect are implemented.

According to an eighth aspect, a network-side device is provided and includes a processor and a communication interface. The processor is configured to determine target antenna selection information of a target sensing device based on target information in a case that the target information changes; and the communication interface is configured to send the target antenna selection information, where the target sensing device includes a device for determining updated antenna selection information; or the communication interface is configured to receive target antenna selection information from a first device; and the processor is configured to perform an antenna selection operation based on the target antenna selection information, where an antenna selected by the antenna selection operation is used to send or receive a first signal.

According to a ninth aspect, a communication system is provided and includes a first sensing device and a first device. The first sensing device may be configured to perform the steps of the sensing processing method according to the second aspect. The first device may be configured to perform the steps of the sensing processing method according to the first aspect.

According to a tenth aspect, a readable storage medium is provided. The readable storage medium stores a program or instructions. When the program or instructions are executed by a processor, the steps of the method according to the first aspect are implemented, or the steps of the method according to the second aspect are implemented.

According to an eleventh aspect, a chip is provided. The chip includes a processor and a communication interface. The communication interface is coupled to the processor. The processor is configured to run a program or instructions to implement the steps of the method according to the first aspect or implement the steps of the method according to the second aspect.

According to a twelfth aspect, a computer program or program product is provided. The computer program or program product is stored in a storage medium. The computer program or program product is executed by at least one processor to implement the steps of the method according to the first aspect or implement the steps of the method according to the second aspect.

In the embodiments of this application, in the case that the target information changes, the first device determines the target antenna selection information of the target sensing device based on the target information; and the first device sends the target antenna selection information, where the target sensing device includes at least one of the sending device for sending the first signal and the receiving device for receiving the first signal, and the target antenna selection information is used for the target sensing device to perform the antenna selection for the first signal. In this way, because the target antenna selection information of the target sensing device is determined based on the target information, the antenna selection information of the target sensing device can be updated based on a current sensing environment, and sensing performance can be effectively improved.

### BRIEF DESCRIPTION OF DRAWINGS

FIG. 1 is a structural diagram of a network to which an embodiment of this application can be applied;

FIG. 2 is a flowchart of a sensing processing method according to an embodiment of this application;

FIG. 3 is a first exemplary diagram of sensing in a sensing processing method according to an embodiment of this application;

FIG. 4 is a second exemplary diagram of sensing in a sensing processing method according to an embodiment of this application;

FIG. 5 is a third exemplary diagram of sensing in a sensing processing method according to an embodiment of this application;

FIG. 6 is a flowchart of another sensing processing method according to an embodiment of this application;

FIG. 7 is a structural diagram of a sensing processing apparatus according to an embodiment of this application;

FIG. 8 is a structural diagram of another sensing processing apparatus according to an embodiment of this application;

FIG. 9 is a structural diagram of a communication device according to an embodiment of this application;

FIG. 10 is a structural diagram of a terminal according to an embodiment of this application; and

FIG. 11 is a structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the New Radio (NR) system is described for an illustrative purpose, and NR terms are used in most of the following descriptions. These technologies may also be applied to other applications than an NR system application, for example, a 6th Generation (6G) communication system.

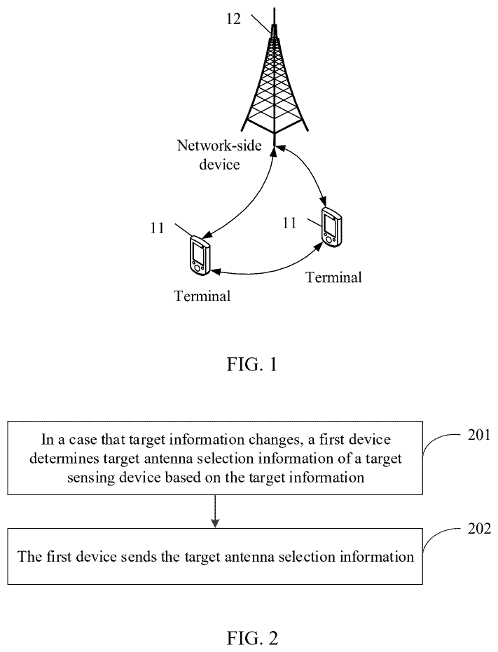

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR) or Virtual Reality (VR) device, a robot, a wearable device, Vehicle User Equipment (VUE), Pedestrian User Equipment (PUE), a smart home (a home device having a wireless communication function, such as a refrigerator, a television, a washing machine, or furniture), a game console, a Personal Computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network element. The access network device may include a base station, a Wireless Local Area Network (WLAN) access point, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNodeB, a Transmission and Reception Point (TRP), or another appropriate term in the art. As long as the same technical effect is achieved, the base station is not limited to specific technical terms. It should be noted that in the embodiments of this application, only a base station in an NR system is used as an example for description, but a specific type of the base station is not limited.

For ease of understanding, the following describes some content in the embodiments of this application.

### I. Integrated Sensing and Communication

Wireless communication and radar sensing have been developing in parallel, but an intersection thereof is limited. Wireless communication and radar sensing have many commonalities in signal processing algorithms, devices, and system architectures to some extent. In recent years, the two systems have drawn more attention of researchers in terms of coexistence, cooperation, and joint design.

Extensive research performed by people early on coexistence of communication and radar systems focuses on development of effective interference management technologies to enable two separately deployed systems to run smoothly without interfering with each other. Although radar and communication systems may be co-located or even physically integrated, they transmit two different signals in time/frequency domain. They cooperate to share same resources to minimize interference with each other while working simultaneously. Corresponding measures include beamforming, cooperative spectrum sharing, primary and secondary spectrum sharing, dynamic coexistence, and the like. However, effective interference cancellation usually has strict requirements on node mobility and information exchange between nodes. Therefore, an improvement of spectrum efficiency is actually limited. Because interference in the coexisting systems is caused by transmitting two independent signals, naturally, there is a question of whether one transmit signal can be used for both communication and radar sensing. The radar system usually uses specially designed waveforms, such as short pulses and chirps, which can implement high-power radiation and simplified receiver processing. However, these waveforms are not necessary for radar detection. For example, a passive radar or passive sensing uses different radio signals as sensing signals.

Machine learning, and in particular, deep learning, further promote use of non-dedicated radio signals for radar sensing. With these technologies, conventional radars are developing toward more universal wireless sensing. Wireless sensing herein may broadly refer to retrieving information from a received radio signal, rather than modulating communication data into a signal at a transmitter. For wireless sensing related to a location of a sensing target, common signal processing methods may be used to estimate a target signal reflection delay, an Angle of Arrival (AOA), an Angle of Departure (AOD), a Doppler parameter, and other dynamic parameters. Physical characteristics of the sensing target can be implemented by measuring a device, an object, or an inherent pattern signal. The two sensing modes may be referred to as sensing parameter estimation and pattern recognition respectively. In this sense, wireless sensing refers to more general sensing technologies and applications that use radio signals.

Integrated Sensing and Communication (ISAC) has a potential to integrate wireless sensing into a large-scale mobile network, which is referred to as a Perceptive Mobile Network (PMN) herein. The PMN may evolve from a current 5G mobile network and is expected to become a ubiquitous wireless sensor network while providing stable and high-quality mobile communication services. The PMN may be built on a mobile network infrastructure in the related art, and there is no need to make great changes to the network structure and devices. The PMN will exploit maximum capabilities of the mobile network and avoid high infrastructure costs for separately constructing a new wide-area wireless sensor network. As coverage expands, integrated sensing and communication capabilities are expected to implement many new applications. The perceptive mobile network can provide both communication and wireless sensing services, and will probably become a ubiquitous wireless sensing solution due to its large broadband coverage and strong infrastructure. Its jointly coordinated communication and sensing capabilities will increase productivity of our society and help produce plenty of new applications that cannot be effectively implemented by the sensor network in the related art. Its potential has been proved in some early work using radio signals for passive sensing, such as traffic monitoring, weather forecast, and rainfall remote sensing based on Global System for Mobile Communications (GSM) radio signals. The perceptive mobile network can be widely applied to communication and sensing in the fields of transportation, communications, energy, precision agriculture, and security. However, solutions in the related art are either unfeasible or inefficient. The perceptive mobile network can also provide complementary sensing capabilities for the sensor network in the related art, have unique day and night operation capabilities, and can penetrate fog, leaves, or even solid objects.

### II. Array Radar

For a sensing technology based on a phased array radar, currently, there are mature hardware implementation solutions and signal processing methods. The phased array radar uses an entire array for beamforming, which can form a narrow beam with a high gain and high directivity to help increase a Signal Noise Ratio (SNR). However, a beam width of the phased array radar determines an angular resolution. When a sensing area is large, beam sweeping is required, and a plurality of targets cannot be distinguished when distances between the targets are less than the beam width. In addition, a maximum quantity of detectable targets is limited.

Transmit signals of different antennas of a Multiple-Input Multiple-Output (MIMO) radar are independent (quasi-orthogonal or orthogonal) of each other, and beams are generally wide. Given a same quantity of antennas, a large-aperture virtual array can be formed by properly arranging antenna positions, thereby improving the angular resolution. In addition, the MIMO radar has a strong clutter suppression capability. Quasi-orthogonality means that transmit signals of different transmit antennas are not completely orthogonal and have cross-correlation, but the cross-correlation is weak. For example, the cross-correlation is represented by a correlation coefficient, which is less than 0.5, and the cross-correlation is considered as weak.

In a future integrated sensing and communication scenario, sensing based on a radar technology, such as device-free positioning and trajectory tracking of pedestrians, motor vehicles, unmanned aerial vehicles, and the like, often needs to perceive one or more targets or events in an area. Before that, it may be necessary to detect an area with large angular coverage and recognize an approximate area in which the target is located. In the integrated sensing and communication scenario, different from a conventional radar scenario, a service coverage distance is generally tens to hundreds of meters, and notable clutter is easily formed by a surrounding environment and objects, causing severe impact on sensing performance. In the integrated sensing and communication scenario, signal multipath propagation can increase a communication capacity, but the case is more complicated for sensing. A part of the propagation becomes clutter, and the other part may also help improve sensing performance.

A majority of future communication systems will be MIMO systems, and the sensing technology based on the array radar is a major development trend. For simplicity, a MIMO integrated sensing and communication system may be referred to as a MIMO-ISAC system. MIMO radars have been widely applied in the field of radar detection, but in the field of integrated sensing and communication, an antenna selection method of the MIMO-ISAC system and a corresponding adaptive method are still unclear.

### III. Principle of a MIMO Radar Virtual Array

A concept of a virtual array in the MIMO radar is also used in an improvement of sensing accuracy of the MIMO-ISAC system. The following provides a brief description. Considering that a total quantity of MIMO radar transmit array antennas is M, position coordinates of each transmit antenna are x_{T,m}, m=0, 1, . . . , M−1; and a total quantity of receive array antennas is N, and coordinates of each receive antenna are x_{R,n}, n=0, 1, . . . , N−1 Assuming that transmit signals of the transmit antennas are orthogonal,

$$\int {s}_{m} ( t ) {s}_{k}^{*} ( t ) d t = {δ}_{m k} \qquad ( 1 )$$

where sₘ(t) represents a transmit signal of an m^{th} antenna, sₖ(t) represents a transmit signal of a k^{th} antenna, and δₘₖ is a Dirac function. In this case, each receive antenna of a receiver uses M matched filters to separate transmit signals. Therefore, the receiver obtains NM received signals in total. Considering one far-field point target, a target response obtained by an m^{th} matched filter of an n^{th} receive antenna may be expressed as:

$${y}_{n , m}^{( t )} = {α}^{( t )} exp [ j \frac{2 π}{λ} {u}_{t}^{T} ( {x}_{T , m} + {x}_{R , n} ) ] \qquad ( 2 )$$

where μₜ is a unit vector pointing from a radar transmitter to the point target, α^{(r)} is a reflection coefficient of the point target, and λ is a carrier wavelength of a transmit signal.

It can be learned that a phase of a reflected signal is determined by a transmit antenna and a receive antenna together. Equivalently, the target response in equation (2) is completely the same as a target response obtained by an array with NM carriers. Position coordinates of the equivalent array antenna are:

$$\{ {x}_{T , m} + {x}_{R , n} \vert m = 0 , 1 , … , M - 1 ; n = 0 , 1 , … , N - 1 \} \qquad ( 3 )$$

It should be understood that in actual deployment of the MIMO radar, by properly setting positions of a transmit array and/or a receive array, an array including NM non-overlapping virtual antennas can be constructed by using only N+M physical antennas. Because the virtual array can often form a larger array aperture, a better angular resolution can be obtained.

If there are L targets, assuming that there is correlation between transmit signals of the transmit antennas, a received signal of the MIMO radar after range-Doppler filtering (only angle estimation is analyzed herein, assuming that a time delay and Doppler parameters have been compensated at a receiver side) is as follows:

$$y ( t ) = {\sum }_{l = 1}^{L} {α}_{l} A ( {θ}_{l} ) s ( t ) + w ( t ) , t ∈ [ 0 , {T}_{0} ] \qquad ( 4 )$$

where αₗ is a reflection coefficient and a reflection delay of an l^{th} target, T₀ is a length of a transmit signal, and A(θ) meets:

$$A ( θ ) = {a}_{R} ( θ ) {a}_{T}^{T} ( θ ) \qquad ( 5 )$$

$$where {a}_{R} ( θ ) = {[ {e}^{j {ω}_{c} {τ}_{R , 1} ( θ )} , … , {e}^{j {ω}_{c} {τ}_{R , N} ( θ )} ]}^{T} \qquad ( 6 )$$

$${a}_{T} ( θ ) = {[ {e}^{- j {ω}_{c} {τ}_{T , 1} ( θ )} , … , {e}^{- j {ω}_{c} {τ}_{T , M} ( θ )} ]}^{T} \qquad ( 7 )$$

$$s ( t ) = {[ {s}_{1} ( t ) , … , {s}_{M} ( t ) ]}^{T} \qquad ( 8 )$$

where A(θ) is a steering vector matrix of an N×M MIMO radar, equations (6) and (7) are steering vectors of receive and transmit arrays respectively, and τ_{T,m}, m=0, 1, . . . , M−1 and T_{R,n}, n=0, 1, . . . , N−1 are signal propagation delays of the transmit and receive arrays relative to a reference point respectively. A correlation matrix of transmit signals of the transmit antennas is:

$${R}_{s} = {\int }_{{τ}_{0}} s ( t ) {s}^{H} ( t ) dt = [ \begin{matrix}1 & {β}_{12} & … & {β}_{1 M} \\ {β}_{21} & 1 & … & {β}_{2 M} \\ ⋮ & ⋮ & ⋱ & ⋮ \\ {β}_{M 1} & {β}_{M 1} & … & 1\end{matrix} ] \qquad ( 9 )$$

where βᵢⱼ is a correlation coefficient of transmit signals of an i^{th} transmit antenna and a j^{th} transmit antenna.

It can be proved that [5, Appendix 4A], the maximum likelihood estimation of the parameter θ in the equation (4) can be obtained based on an NM×1 vector:

$$η = {\int }_{{T}_{0}} {s}^{*} ( t ) ⊗ y ( t ) d t \qquad ( 10 )$$

Generally, to reduce complexity of a receiver algorithm, it is expected that η is a statistically independent sufficient statistic [5]. Eigenvalue decomposition is performed on the correlation matrix of the transmit signals, and Rₛ=UΛU_{H} is obtained. Correspondingly, an actual transmit signal may be considered as a linear transformation of a group of orthogonal signals \tilde{s}(t), that is:

$$s ( t ) = U {Λ}^{1 / 2} \tilde{s} ( t ) \qquad ( 11 )$$

The foregoing is substituted into equation (4). Because R_{\tilde{s}}=∫_{T}_{₀}\tilde{s}(t)\tilde{s}^{H}(t)dt=I_{M×M}, the following is obtained:

$$y ( t ) = {\sum }_{l 1}^{L} {α}_{l} {e}^{j {ω}_{D} t} A ( {θ}_{l} ) U {Λ}^{1 / 2} \tilde{s} ( t - {τ}_{l} ) + w ( t ) , t ∈ [ 0 , {T}_{0} ] \qquad ( 12 )$$

Correspondingly, equation (10) becomes

$$\tilde{η} = {\sum }_{l = 1}^{L} {α}_{l} d ( {θ}_{l} ) + vec [ {\int }_{{T}_{0}} w ( t ) {\tilde{s}}^{H} ( t ) d t ] \qquad ( 13 )$$

An equivalent virtual steering vector with NM×1 dimensions is expressed as:

$$d ( {θ}_{l} ) = v e c ( A ( {θ}_{l} ) U {Λ}^{1 / 2} ) \qquad ( 14 )$$

For the phased array radar, signals of all transmit antennas are coherent. In this case, Rₛ=uu^{H} includes only one non-zero eigenvalue. Therefore,

$$U {Λ}^{1 / 2} = [ {\underbrace{u , {0}_{M \times 1} , … , {0}_{M \times 1}}}_{M - 1 ↑} ]$$

In this case,

$${d}_{coherent} ( θ ) = [ {a}_{R} ( θ ) ( {a}_{T}^{T} ( θ ) u ) ; {0}_{N \times ( M - 1 )} ] \qquad ( 15 )$$

In this case, a quantity of effective array elements of the virtual array is only N. For a MIMO radar whose transmit signals of transmit antennas are completely orthogonal, Rₛ=I_{M×M}, and UΛ^{1/2}I_{M×M}. In this case,

$${d}_{orthogonal} ( θ ) = v e c ( A ( θ ) {I}_{M \times M} ) = {a}_{T} ( θ ) ⊗ {a}_{R} ( θ ) \qquad ( 16 )$$

As can be learned from the above, orthogonality (correlation) between the transmit signals of the transmit antennas affects the quantity of effective array elements of the virtual array of the MIMO radar, and further affects flexibility of signal processing at the receiver side. Therefore, a sensing processing method is provided in this application.

A sensing processing method provided in the embodiments of this application is hereinafter described in detail by using some embodiments and application scenarios thereof with reference to the accompanying drawings.

Referring to FIG. 2, an embodiment of this application provides a sensing processing method. As shown in FIG. 2, the sensing processing method includes:

Step 201: In a case that target information changes, a first device determines target antenna selection information of a target sensing device based on the target information.

Step 202: The first device sends the target antenna selection information.

The target sensing device includes at least one of a sending device for sending a first signal and a receiving device for receiving the first signal, and the target antenna selection information is used for the target sensing device to perform an antenna selection for the first signal.

In some embodiments, the target information may be understood as information for determining whether to update the antenna selection information, and in some embodiments, the target information may include at least one of the following:
a sensing result obtained by performing a first service associated with the first signal in a preset time period;
antenna selection information for performing the first service by the target sensing device in the preset time period;
antenna array information of the target sensing device;
first status information of a sensing target;
channel information;
resource information associated with the first service; and
first information for determining a sensing device.

It should be noted that the target information changes in a case that a preset condition is met, where the preset condition may include at least one of the following:
a change in a dynamic parameter of the sensing target, where the dynamic parameter includes at least one of speed, angle, and distance;
a change in a quantity or density of sensing targets in a sensing area;
a change in environmental clutter in the sensing area;
a change in environmental interference in the sensing area;
a change in available service time-frequency resources;
a change in available antenna resources; and
a change in the first signal.

The change in the quantity or density of the targets and environmental interference may be understood as: a variation of a corresponding parameter value is greater than a preset threshold. Because the changes of the foregoing parameters affect sensing performance, sensing performance can be maintained or improved by adaptively adjusting the antenna selection information. The change in the available antenna resources may be understood as a change in overall available antenna resources of all sensing devices performing the first service, for example, a change in the overall available antenna resources due to a change in available antenna resources on a sensing device, or a change in the overall available antenna resources caused by adding or removing or updating a sensing device. The change in the first signal may be understood as a change in an orthogonal mode or a sequence of the first signal, or a change in a sequence of a signal of at least one transmit antenna in the first signal.

In this embodiment of this application, the first device may receive the target information from at least one sensing device associated with the first signal, or the first device may receive part of the target information from at least one sensing device, and a first sensing device determines another part of the target information through calculation, or the first device may determine the target information directly through calculation. This is not further limited herein. The sensing device may be referred to as a sensing node, and the sensing device includes the sending device and the receiving device. The sending device and the receiving device may be a same device or different devices. The first device may be understood as a network-side device, for example, may be a device in a core network or a base station. It should be understood that the determining target antenna selection information of a target sensing device based on the target information may be understood as determining the target antenna selection information of the target sensing device based on target information of the target sensing device, or determining the antenna selection information of the target sensing device based on both target information of the target sensing device and target information of another sensing device in at least one sensing device. For example, in some embodiments, when antenna resources of the target sensing device need to be increased or decreased because a distance between the sensing target and the target sensing device changes, the target antenna selection information of the target sensing device may be determined by combining target information of all sensing devices. For example, in some embodiments, in a case that channel information of the target sensing device changes, the target antenna selection information of the target sensing device may be determined based on the target information of the target sensing device.

In some embodiments, the target antenna selection information may include at least one of antenna selection information of the sending device and antenna selection information of the receiving device. In a case that the target antenna selection information includes the antenna selection information of the sending device, the antenna selection information of the sending device may be updated based on the target antenna selection information, and in this case, the target sensing device includes the sending device. In a case that the target antenna selection information includes the antenna selection information of the receiving device, the antenna selection information of the receiving device may be updated based on the target antenna selection information, and in this case, the target sensing device includes the receiving device.

The first service may be understood as a sensing service or an integrated sensing and communication service. The preset time period may be understood as a time period before the first device determines the target antenna selection information, that is, a time period before the antenna selection information is updated. In other words, the antenna selection information may be updated based on a sensing result of the sensing service performed within a preset time period before the antenna selection information is updated.

In some embodiments, in some embodiments, the first signal is a set of transmit signals of transmit antennas in a multiple-input multiple-output integrated sensing and communication MIMO-ISAC system, and the transmit signals of the transmit antennas in the MIMO-ISAC system are mutually orthogonal or quasi-orthogonal. It should be understood that in the MIMO-ISAC system, a signal of each transmit antenna may be a signal having only a sensing function but not including transmission information, such as pseudo-random sequences used in synchronization and reference signals in the related art, including an m sequence, a Zadoff-Chu sequence, a Gold sequence, and the like; or may be a single-frequency Continuous Wave (CW), a Frequency Modulated CW (FMCW) commonly used in a radar, an ultra wideband Gaussian pulse, or the like; or may be a newly designed special sensing signal with good correlation characteristics and a low Peak-to-Average Power Ratio (PAPR), or a newly designed integrated sensing and communication signal that not only carries information, but also has good sensing performance.

In some embodiments, the first status information may include one or more measurement parameter values, such as position coordinates of the sensing target, a distance from the sensing target to the sending device, a moving speed of the sensing target, and the like. Before a sensing measurement is performed on the sensing target, the first status information may be determined based on prior information of the sensing target. After the sensing measurement is performed, the first status information may be updated based on measurement parameter values obtained in the sensing measurement. The sensing result may be determined based on measurement parameter values obtained in one or more sensing measurements. The following uses an example for description.

In some embodiments, the sensing result may be a sensing parameter value obtained in one sensing measurement. For example, in a sensing scenario in which position sensing is performed on the sensing target, the sensing result may be the position coordinates of the sensing target.

In some embodiments, the sensing result may be a target result determined based on a sensing parameter value obtained in one sensing measurement. For example, in a sensing scenario in which contour sensing is performed on the sensing target, the sensing result may be determined through calculation based on a plurality of sensing parameter values such as the position coordinates of the sensing target, and an azimuth of departure and an elevation of departure of the sensing target.

In some embodiments, the sensing result may be determined based on sensing parameter values obtained in a plurality of sensing measurements. For example, in a sensing scenario in which trajectory sensing is performed on the sensing target, the sensing result may be a trajectory determined by the position coordinates of the sensing target obtained in the plurality of sensing measurements.

In this embodiment of this application, in the case that the target information changes, the first device determines the target antenna selection information of the target sensing device based on the target information; and the first device sends the target antenna selection information, where the target sensing device includes at least one of the sending device for sending the first signal and the receiving device for receiving the first signal, and the target antenna selection information is used for the target sensing device to perform the antenna selection for the first signal. In this way, because the target antenna selection information of the target sensing device is determined based on the target information, the antenna selection information of the target sensing device can be updated based on a current sensing environment, and sensing performance can be effectively improved.

In some embodiments, an orthogonal type of a transmit signal of each transmit antenna includes at least one of the following: Time division multiplexing (TDM), Frequency Division Multiplexing (FDM), Doppler Division Multiplexing (DDM), and Code Division Multiplexing (CDM).

In this embodiment of this application, when the orthogonal type of the transmit signal of each transmit antenna includes TDM, it may be understood that the transmit signal of the transmit antenna includes a TDM signal; when the orthogonal type of the transmit signal of each transmit antenna includes FDM, it may be understood that the transmit signal of the transmit antenna includes an FDM signal; when the orthogonal type of the transmit signal of each transmit antenna includes DDM, it may be understood that the transmit signal of the transmit antenna includes a DDM signal; or when the orthogonal type of the transmit signal of each transmit antenna includes CDM, it may be understood that the transmit signal of the transmit antenna includes a CDM signal. Further, in a case that the orthogonal type of the transmit signal of each transmit antenna includes two orthogonal types, the transmit signal of the transmit antenna may be understood as a combination of two signals. For example, when the orthogonal type of the transmit signal of each transmit antenna includes TDM and FDM, it may be understood that the transmit signal of the transmit antenna includes a combination of a TDM signal and an FDM signal.

In some embodiments, that the transmit signals of the transmit antennas in the MIMO-ISAC system are mutually orthogonal or quasi-orthogonal includes at least one of the following:
transmit signals of at least two transmit antennas in the MIMO-ISAC system respectively use mutually orthogonal time domain resources;
transmit signals of at least two transmit antennas in the MIMO-ISAC system respectively use mutually orthogonal frequency domain resources;
transmit signals of at least two transmit antennas in the MIMO-ISAC system use a same frequency domain pattern, and the transmit signals of the transmit antennas in the MIMO-ISAC system are transmitted separately at different transmission moments;
transmit signals of at least two transmit antennas in the MIMO-ISAC system are respectively different circularly shifted versions of preset time-frequency patterns in frequency domain and/or time domain;
the transmit signals of the transmit antennas in the MIMO-ISAC system have a plurality of pulse periods, their frequency domain resources partially overlap or do not overlap, and frequency domain resources used by the transmit signals of the transmit antenna are changed in a plurality of different signal pulse periods according to preset rules;
transmit signals of at least two transmit antennas in the MIMO-ISAC system use a first time domain resource, and a transmit signal of at least one transmit antenna in the MIMO-ISAC system uses a second time domain resource, where the first time domain resource and the second time domain resource are mutually orthogonal, and the transmit signals of the at least two transmit antennas using the first time domain resource use mutually orthogonal frequency domain resources;
transmit signals of at least two transmit antennas in the MIMO-ISAC system respectively use mutually orthogonal code domain resources; and
transmit signals of at least two transmit antennas in the MIMO-ISAC system respectively use mutually orthogonal Doppler frequency domain resources.

That transmit signals of at least two transmit antennas respectively use mutually orthogonal code domain resources may be understood as: transmit signals of different transmit antennas in the at least two transmit antennas are respectively multiplied by a group of orthogonal codes (for example, Hadamard codes or Walsh codes). In this case, it may be understood that the transmit signals of the transmit antennas include CDM signals.

That transmit signals of at least two transmit antennas in the MIMO-ISAC system respectively use mutually orthogonal Doppler frequency domain resources may be understood as: the transmit signals of the transmit antennas include DDM signals. For example, in some embodiments, the plurality of signals include at least two DDM signals, and the at least two DDM signals are respectively transmitted through different transmit antennas. Change rates of initial pulse phases or target phases of the at least two DDM signals are different, where the target phases are phases of the DDM signals at different sampling moments in a pulse. In some embodiments, the at least two DDM signals meet either of the following:
initial pulse phases of DDM signals transmitted by a same transmit antenna change linearly with time, and phases of signals at different sampling moments in the pulse remain constant; and
target phases of DDM signals transmitted by a same transmit antenna change linearly with time.

In some embodiments, in some embodiments, the first device obtains second information of at least one sensing device, where the at least one sensing device includes the target sensing device;
the first device determines a target configuration parameter based on the second information; and
the first device sends the target configuration parameter to the at least one sensing device, where the target configuration parameter is used for the at least one sensing device to perform a first service associated with the first signal.

In this embodiment of this application, the target configuration parameter may include an initial configuration parameter of the sending device and an initial configuration parameter of the receiving device. The sensing device may include only the sending device or the receiving device, or may include the sending device and the receiving device. For example, in a case that the sensing device is the sending device or the receiving device, that the first device sends the target configuration parameter to the at least one sensing device may be understood as: the first device may send a corresponding initial configuration parameter to each sensing device, or may send initial configuration parameters of all sensing devices to each sensing device. In other words, the first device sends the initial configuration parameter of the sending device to the sending device, or sends the initial configuration parameter of the sending device and the initial configuration parameter of the receiving device to the sending device.

In some embodiments, the target configuration parameter includes signal configuration information of the first signal, antenna selection information of the sending device, and antenna selection information of the receiving device. The target configuration parameter may be understood as at least part of initial configuration parameters. In other words, the target configuration parameter includes part or all of all initial configuration parameters required for the sending device and the receiving device to perform the first service for the first time.

In some embodiments, in some embodiments, the method further includes:
the first device obtains second information of at least two sensing devices, where the at least two sensing devices include the target sensing device;
the first device determines a first configuration parameter based on second information of the sending device of the at least two sensing devices, where the first configuration parameter is used for the sending device to perform a first service associated with the first signal; and
the first device sends the first configuration parameter and second information of the receiving device to the sending device, where the second information of the receiving device is used to determine a second configuration parameter, and the second configuration parameter is used for the receiving device of the at least two sensing devices to perform the first service.

In this embodiment of this application, each sensing device may report its own antenna array information, first status information, channel information, and resource information. For example, when the sending device and the receiving device are different sensing devices, the sending device may report antenna array information, first status information, and resource information of the sending device, and the receiving device may report antenna array information, first status information, channel information, and resource information of the receiving device. The first configuration parameter may be understood as at least part of initial configuration parameters. In other words, the first configuration parameter includes part or all of the initial configuration parameters required for the sending device to perform the first service for the first time. The second configuration parameter may be understood as at least part of the initial configuration parameters. In other words, the second configuration parameter includes part or all of the initial configuration parameters required for the receiving device to perform the first service for the first time.

In some embodiments, in some embodiments, the first configuration parameter includes signal configuration information of the first signal and antenna selection information of the sending device.

In some embodiments, in some embodiments, the second configuration parameter includes signal configuration information of the first signal and antenna selection information of the receiving device.

In some embodiments, content included in the second information may be set based on an actual requirement. For example, in some embodiments, the second information includes at least one of the following: antenna array information, first status information of the sensing target, channel information, resource information associated with the first service, and first information for determining a sensing device.

It should be noted that a computing device that calculates the sensing result may be the first device or the sensing device, and is not further limited herein. A computing node may obtain the sensing result through calculation based on third information, and if the computing node lacks one or more pieces of third information, the computing node may obtain the missing information from other devices. For example, in some embodiments, when the first device is a computing device, the method further includes:
the first device obtains third information; and
the first device obtains a sensing result through calculation based on the third information, where
the third information includes:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and
signal configuration information of the first signal.

It should be understood that the antenna array information is used to determine steering vectors (including the first steering vector and the second steering failure), where the steering vectors may be determined by the sensing device or the first device. It should be noted that after the first device sends the target antenna selection information, the first device needs to obtain third information updated by the sensing device that updates the antenna selection information based on the target antenna selection information.

To reduce transmission overheads, the antenna array information reported by the sensing device may include only part of the antenna array information, for example, include only position information of a selected panel (panel) and/or antenna array element relative to a local reference point in an array.

In some embodiments, the signal configuration information may include at least one of the following:
a resource location parameter, where the resource location parameter is used to control a time-frequency resource location of the first signal;
a resource pattern parameter, where the resource pattern parameter is used to control a basic time-frequency resource pattern of the first signal;
a resource modulation parameter, where the resource modulation parameter is used to control phase modulation of the first signal;
a resource coding parameter, where the resource coding parameter is used to control an orthogonal code resource configuration of the first signal based on code division multiplexing CDM;
a signal sequence type;
a signal sequence length; and
an initial seed for producing the first signal.

In some embodiments, in some embodiments, the signal configuration information may further include at least one of a signal correlation matrix and a beamforming matrix.

It should be noted that the signal correlation matrix and the beamforming matrix may be obtained by the first device or by the sensing device through calculation.

In some embodiments, the third information meets at least one of the following:
in a case that the sending device performs precoding, the third information further includes precoding information; or
in a case that the sending device performs beamforming, the third information further includes beamforming matrix information.

In some embodiments, that the first device obtains third information includes any one of the following:
in a case that the first device locally stores all of the third information, the first device obtains the locally stored third information;
in a case that the first device locally stores first sub-information but does not store second sub-information, the first device obtains the locally stored first sub-information, and obtains the second sub-information from at least one sensing device, where the first sub-information is part of the third information and the second sub-information is another part of the third information; or
in a case that the first device locally stores all of the third information, the first device obtains the third information from at least one sensing device.

In some embodiments, in some embodiments, when the first device is not a computing device, the first device may send at least part of the third information to a computing device. For example, the method further includes:
the first device sends fourth information to a computing device, where the fourth information is used to calculate a sensing result, the computing device is a device for calculating the sensing result, and the fourth information includes at least one of the following:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and signal configuration information of the first signal.

In this embodiment of this application, the fourth information may be at least part of the third information. In some embodiments, the fourth information meets at least one of the following:
in a case that the sending device performs precoding, the fourth information further includes precoding information; or
in a case that the sending device performs beamforming, the fourth information further includes beamforming matrix information.

Further, after the computing device obtains the sensing result through calculation, the computing device may send the sensing result to the first device, so that the first device updates the antenna selection information. In other words, after the first device sends the fourth information to the computing device, the method further includes:
the first device receives the sensing result from the computing device.

In some embodiments, the antenna selection information includes at least one of the following:
an identity of an antenna array element that sends the first signal;
an identity of an antenna array element that receives the first signal;
an identity of a first antenna panel that sends the first signal;
an identity of a second antenna panel that receives the first signal;
position information of the antenna array element that sends the first signal relative to a preset local reference point of an antenna array;
position information of the antenna array element that receives the first signal relative to a preset local reference point of an antenna array;
position information of the first antenna panel that sends the first signal relative to the preset local reference point of the antenna array and position information of the antenna array element for sending the first signal in the first antenna panel relative to a preset unified reference point of the first antenna panel;
position information of the second antenna panel that receives the first signal relative to the preset local reference point of the antenna array and position information of the antenna array element for receiving the first signal in the second antenna panel relative to a preset unified reference point of the second antenna panel;
bitmap information of an antenna array element; and
bitmap information of an array antenna panel.

It should be understood that the foregoing identity may be, for example, an index identity.

The position information may be expressed by using Cartesian coordinates (x, y, z) or spherical coordinates (ρ,φ,θ). The bitmap information may be referred to as bitmap information, where a bitmap of the antenna array element uses “1” to indicate that the array element is selected for sending and/or receiving the first signal, and uses “0” to indicate that the array element is not selected. A bitmap of the array antenna panel uses “1” to indicate that the antenna array element is selected for sending and/or receiving the first signal, and uses “0” to indicate that the antenna array element is not selected (or vice versa).

In some embodiments, in some embodiments, the antenna array information includes at least one of the following:
a set of first identities available for the first service associated with the first signal, where the first identities are identities of antenna array elements;
a mapping relationship between a first identity and a position of an antenna array element in an antenna array;
a mapping relationship between a second identity and a position of an antenna panel in an antenna array in a case that the antenna array includes at least two antenna panels, where the second identity is an identity of an antenna panel;
bitmap rules of antenna array elements;
bitmap rules of antenna panels and bitmap rules of antenna array elements in a single antenna panel in a case that an antenna array includes at least two antenna panels;
an antenna array type;
a quantity of antenna panels included in an antenna array;
a quantity of antenna array elements included in an antenna array;
position information of a predetermined local reference point of an antenna array;
position information of an antenna panel relative to a local reference point of an antenna array in a case that the antenna array includes at least two antenna panels;
position information of an antenna array element relative to a preset local reference point of an antenna array;
position information of an antenna array element in each antenna panel relative to a preset unified reference point of the antenna panel in a case that an antenna array includes at least two antenna panels;
a polarization mode of an antenna with the first identity; and
three-dimensional or two-dimensional pattern information of at least some antenna array elements.

Array element identities (ID) may be unique and correspond to array elements on a one-to-one basis. In a case that an array has a plurality of antenna panels, antenna IDs may not be unique, but antenna panel IDs are unique, and an array element is uniquely determined by antenna panel ID+array element ID.

Assuming that there are 64 array elements in an array, 8 bytes (64 bits) are required to indicate bitmap rules of the antenna array elements.

In some embodiments, the antenna array types may include a planar array, a linear array, a circular array, a cylindrical array, a 2D irregular array, a 3D array, and the like.

In some embodiments, in some embodiments, in a case that the antenna array includes at least two antenna panels, the antenna array information meets at least one of the following:
if the antenna panel is a uniform linear array or planar array, the antenna array information may further include a distance between adjacent antenna panels (panel) in a horizontal direction, a distance between adjacent panels in a vertical direction, a quantity of panels in the horizontal direction, and a quantity of panels in the vertical direction;
if the antenna panel is a uniform circular array or cylindrical array, the antenna array information may further include a distance R from a single-layer circular array panel to a center of a circle, an included angle between connected lines of adjacent single-layer circular array panels and the center of the circle, a distance between adjacent circular array panels, a quantity of single-layer circular array panels, and a quantity of panels in an axial direction of the cylindrical array (if the quantity is 1, the array is a single circular array);
if the antenna panel is an irregular or non-uniform 2D array or 3D array, the antenna array information may further include position coordinates of a panel relative to a local reference point of the antenna array (which may be expressed by using Cartesian coordinates (x, y, z) or spherical coordinates (ρ,φ,θ), and reflected by a list) and a quantity of panels; and a distance between adjacent array elements in a single panel in the horizontal direction, a distance between adjacent array elements in a single panel in the vertical direction, a quantity of array elements in a single panel in the horizontal direction, and a quantity of array elements in a single panel in the vertical direction.

An interval between panels may be measured by a unified local reference point, such as a center point of each panel.

In some embodiments, in some embodiments, the antenna array information meets at least one of the following:
if the antenna array elements are of a uniform linear array or planar array, the antenna array information may further include a distance between adjacent array elements in the horizontal direction, a distance between adjacent array elements in the vertical direction, a quantity of array elements in the horizontal direction, and a quantity of array elements in the vertical direction;
if the antenna array elements are of a uniform circular array or cylindrical array, the antenna array information may further include a distance R from a single-layer circular array element to the center of the circle, an included angle between connected lines of adjacent single-layer circular array elements and the center of the circle, a distance between adjacent array elements in the axial direction of the cylindrical array, a quantity of single-layer circular array elements, and a quantity of array elements in the axial direction of the cylindrical array (if the quantity is 1, the array is a single circular array); and
if the antenna array elements are of an irregular or non-uniform 2D array or 3D array, the antenna array information may further include position coordinates of an array element relative to a local reference point of the antenna array (which may be expressed by using Cartesian coordinates (x, y, z) or spherical coordinates (ρ, φ, θ), and reflected by a list) and a quantity of array elements.

In some embodiments, the polarization mode of the antenna may include vertical polarization, horizontal polarization, +45° polarization, circular polarization, and the like.

The first status information includes at least one of the following:
a first measurement value of a first measurement parameter of the sending device, where the first measurement parameter includes at least one of an Azimuth of Departure (AOD) and an Elevation of Departure (EOD) of the sensing target;
a second measurement value of a second measurement parameter of the receiving device, where the second measurement parameter includes at least one of an Azimuth of Arrival (AOA) and an Elevation of Arrival (EOA) of the sensing target;
a standard deviation or a variance of the first measurement values obtained in at least two sensing measurements;
a standard deviation or a variance of the second measurement values obtained in at least two sensing measurements;
a mean, a standard deviation, or a variance of at least two first values, where the first value is a difference between the first measurement value obtained in one sensing measurement and a first predictor corresponding to the first measurement parameter;
a mean, a standard deviation, or a variance of at least two second values, where the second value is a difference between the second measurement value obtained in one sensing measurement and a second predictor corresponding to the second measurement parameter;
a distance from the sensing target to the sending device;
a distance from the sensing target to the receiving device;
a moving speed of the sensing target;
a moving direction of the sensing target;
a first velocity component, where the first velocity component is a magnitude of a velocity component of the sensing target, obtained in one sensing measurement, in at least one coordinate axis direction in a preset Cartesian coordinate system;
a mean, a standard deviation, or a variance of the first velocity components obtained in at least two sensing measurements;
a mean, a standard deviation, or a variance of at least two third values, where the third value is a difference between the first velocity component obtained in one sensing measurement and a third predictor corresponding to the velocity component;
position coordinates of the sensing target;
a mean, a standard deviation, or a variance of the position coordinates of the sensing target that are obtained in at least two sensing measurements;
a mean, a standard deviation, or a variance of at least two fourth values, where the fourth value is a difference between the position coordinates of the sensing target that are obtained in one sensing measurement and a fourth predictor corresponding to the position coordinates;
a third measurement value of a third measurement parameter of the first signal received on at least one antenna array element on the receiving device, where the third measurement parameter includes received power, a signal-to-noise ratio SNR, and a Signal to Interference plus Noise Ratio (SINR);
a mean, a standard deviation, or a variance of at least two third measurement values; a mean, a standard deviation, or a variance of at least two fifth values, where the fifth value is a difference between the third measurement value obtained in one sensing measurement and a fifth predictor corresponding to the third measurement parameter; a mean, a standard deviation, or a variance of the first signal received on at least two antenna array elements in an antenna array of the receiving device;
a fourth measurement value of a fourth measurement parameter of a power spectrum of the sensing target, where the fourth measurement parameter includes at least one of an average angle of the received first signal and an angle spread of the received first signal;
a mean, a standard deviation, or a variance of at least two sixth values, where the sixth value is a difference between the fourth measurement value obtained in one sensing measurement and a sixth predictor corresponding to the fourth measurement parameter;
a fifth measurement value of a fifth measurement parameter of a delay power spectrum of the sensing target, where the fifth measurement parameter includes at least one of a received signal average delay of the first signal and a received signal delay spread of the first a mean, a standard deviation, or a variance of at least two seventh values, where the seventh value is a difference between the fifth measurement value obtained in one sensing measurement and a seventh predictor corresponding to the fifth measurement parameter;
a sixth measurement value of a sixth measurement parameter of a Doppler power spectrum of the sensing target, where the sixth measurement parameter includes at least one of a received signal average Doppler frequency shift of the first signal and a received signal Doppler spread of the first signal;
a mean, a standard deviation, or a variance of at least two eighth values, where the eighth value is a difference between the sixth measurement value obtained in one sensing measurement and an eighth predictor corresponding to the sixth measurement parameter; environmental clutter power;
a mean, a standard deviation, or a variance of at least two ninth values, where the ninth value is a difference between the environmental clutter power obtained in one sensing measurement and a ninth predictor corresponding to the environmental clutter power;
a seventh measurement value of a seventh measurement parameter, where the seventh measurement parameter includes at least one of a Doppler bandwidth of environmental clutter and a Doppler bandwidth of superposition of the environmental clutter and the sensing target;
a mean, a standard deviation, or a variance of at least two tenth values, where the tenth value is a difference between the seventh measurement value obtained in one sensing measurement and a tenth predictor corresponding to the seventh measurement parameter; a quantity of sensing targets in a preset sensing area;
density of the sensing targets in the preset sensing area; and position coordinates of the sensing area and parameters related to a size of a physical range in a case that the sensing area changes.

In some embodiments, the average angle of the received first signal, the average delay of the received first signal, and the average Doppler frequency shift of the received first signal may be referred to as first-order statistics. The average angle spread of the received first signal, the average delay spread of the received first signal, and the average Doppler spread of the received first signal may be referred to as second-order statistics.

In some embodiments, in some embodiments, the channel information includes fifth information of any antenna pair between the sending device and the receiving device, and the fifth information includes at least one of the following: a channel transmission function, a channel impulse response, Channel State Information (CSI), a Channel Quality Indicator (CQI), a Rank Indicator (RI), and a performance indicator related to communication.

The performance indicator related to communication may include Reference Signal Received Power (RSRP), an SNR, an SINR, a transmission rate or throughput, spectrum efficiency, a bit error rate, a block error rate, and the like.

In some embodiments, in some embodiments, the resource information includes a resource quantity of target resources available for the first service associated with the first signal, and the target resource includes at least one of the following: a time resource, a frequency resource, an antenna resource, a DDM phase modulator resource, and an orthogonal code resource.

The antenna resource may include a quantity of antenna arrays or a quantity of antenna subarrays.

In some embodiments, in some embodiments, the first information includes at least one of the following: a sensing requirement, a service type, Quality of Service (QOS) of sensing or QoS of integrated sensing and communication, prior information of a sensing area, and prior information of the sensing target.

It should be noted that there may be one or more sending devices, and that there may be one or more receiving devices. A quantity of antenna groups selected in the antenna arrays of the sending device and the receiving device is not less than one. In other words, a same sensing node may simultaneously perform a plurality of sensing or integrated sensing and communication services based on the available antenna resources, and each service corresponds to one group of selected antennas.

In some embodiments, part or all of the antenna array information of the sending device and/or the receiving device may be prestored in the first device when the network is deployed.

In some embodiments, a virtual antenna array after an antenna selection is performed by the sending device and/or the receiving device may have overlapping virtual array elements, to increase a received SNR of the first signal through the antenna selection in a case that transmit power of a single antenna array element is fixed.

In some embodiments, the antenna and the antenna array element in this embodiment of this application have a same meaning, and they may also be an antenna subarray including a plurality of antenna array elements physically. Logically, one antenna array element or one antenna subarray corresponds to one antenna port or resource identity. Therefore, a selected object can also be considered as an antenna port or resource ID.

For better understanding this application, the following describes antenna selection adaptation by using some embodiments.

In some embodiments, in some embodiments, in a scenario of trajectory tracking and sensing of a sensing target, with a change in a distance or direction, a distance between antennas or a distance between antennas and a quantity of the antennas need to be changed to maintain or improve an angular resolution. The sensing target may be a moving target such as a motor vehicle, a bicycle, an unmanned aerial vehicle, or a pedestrian. A sensing mode may be a mode in which node A sends a first signal and node B receives the first signal, or node A sends and receives a first signal by itself.

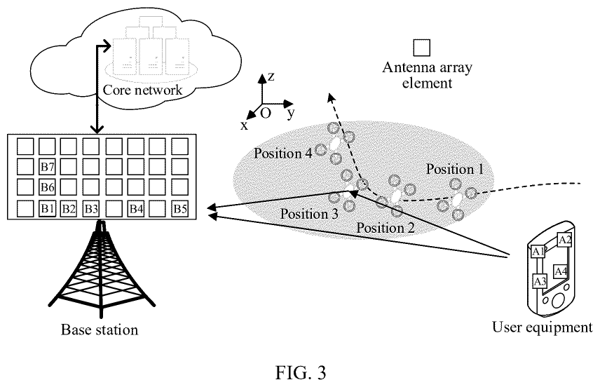

As shown in FIG. 3, using trajectory tracking of an unmanned aerial vehicle as an example for description, it is assumed that node A is a terminal, and that node B is a base station, and that trajectory tracking and sensing are performed on an unmanned aerial vehicle in a sensing area. Relative to the base station, the unmanned aerial vehicle moves from far to near, and the unmanned aerial vehicle changes its direction and flies upward at position 3. At position 1, because the unmanned aerial vehicle is far away from the base station, positioning of the unmanned aerial vehicle requires a high angular resolution. In this case, antenna array elements {A1, A2} of the terminal send a first signal, and antenna array elements {B1, B2, B3, B4, B5} of the base station receive the first signal, so that a virtual array constructed in this way can have a larger aperture in a horizontal direction. When the unmanned aerial vehicle arrives at position 2, the unmanned aerial vehicle is close to the base station. In this case, the antenna array elements {A1, A2} of the terminal send the first signal, and the antenna array elements {B1, B2, B3} of the base station receive the first signal, which can meet the angular resolution requirement, thereby saving part of antennas, ports, or time-frequency resources (in a case that antennas or antenna ports are bound with time-frequency resources). When the unmanned aerial vehicle is at position 3 and position 4, the first device readjusts, based on first status information fed back by a computing node, such as a statistical mean, a variance, or a standard deviation of differences between historical measurement values and predictors of at least one of a distance, a speed, and an angle of the sensing target, the antennas used by the terminal and the base station for sensing. For example, the antenna array elements {A1, A2, A3, A4} of the terminal send the first signal, and the antenna array elements {B1, B2, B3, B6, B7} of the base station receive the first signal, so that a virtual array constructed in this way can have a larger aperture in a vertical direction, thereby ensuring sensing accuracy of a trajectory tracking position of the unmanned aerial vehicle.

In some embodiments, in some embodiments, with a change in a quantity of sensing targets in the sensing area, a quantity of antennas or density of antennas needs to be changed to change a maximum quantity of sensing targets that can be simultaneously sensed.

For sensing of a predetermined dynamic environment, the method of this application may also be used to ensure or improve sensing performance. For example, traffic sensing at an intersection (the traffic sensing may include sensing a quantity of vehicles passing in a time period, a speed and a position (a lane) of each vehicle, and the like).

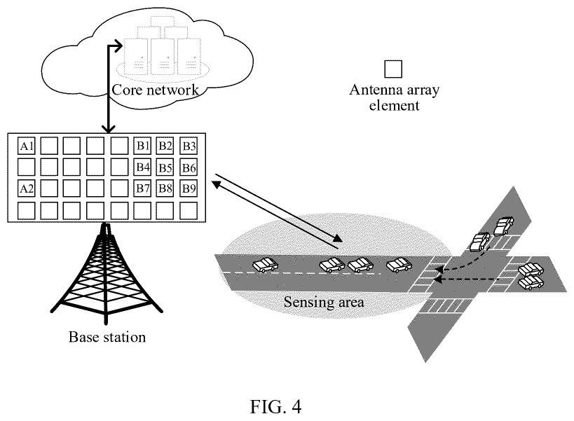

As shown in FIG. 4, a roadside base station senses a traffic flow in a section of a highway in a self-transmit self-receive manner. A MIMO-ISAC system may distinguish vehicles and determine a speed and position of a single vehicle by measuring an echo delay, an angle, and a Doppler frequency of a first signal. A maximum quantity of sensing targets that the MIMO-ISAC can simultaneously sense is determined by a quantity of antennas of a transmit array and a receive array together, [Li, Jian, and Petre Stoica. “MIMO radar with co-located antennas.” IEEE Signal Processing Magazine 24.5 (2007): 106-114, Li, Jian, and Petre Stoica. MIMO radar signal processing. John Wiley & Sons, 2008], that is:

$${L}_{max} ∈ [ \frac{2 ( M + N ) - 5}{3} , \frac{2 MN}{3} ] ,$$

where Lₘₐₓ represents a maximum quantity of sensing targets that can be simultaneously sensed, M is a quantity of transmit antennas, and N is a quantity of receive antennas.

In a time period without a traffic jam, vehicles on a road are sparse. In this case, the base station selects (or the first device instructs the base station to select) the antenna array elements {A1, A2} to send the first signal, and the antenna array elements {B2, B3, B5, B6} to receive the first signal, which can meet a sensing performance requirement (meeting a sensing requirement in first information and/or QoS of sensing or integrated sensing and communication). In a time period with a traffic jam, the first device or the base station adjusts, based on the first status information, such as the quantity or density of the sensing targets in the sensing area, the antenna array elements for receiving the first signal to {B1, B2, B3, B4, B5, B6, B7, B8, B9}, to increase the maximum quantity of sensing targets that the MIMO-ISAC system can simultaneously sense.

In some embodiments, in some embodiments, in a case of a change in the available time-frequency resources or orthogonal code resources of the sensing node, sensing performance needs to be maintained in TDM+antenna selection mode.

A basis for the MIMO-ISAC system to construct a virtual array to improve an angular resolution of sensing is that transmit signals of the selected antennas/subarrays are orthogonal to each other. A method for achieving orthogonality includes at least one of TDM, FDM, CDM, and DDM. Generally, due to the application of massive antenna arrays, antenna resources are more abundant than time-frequency resources and orthogonal code resources, but the antenna resources have constraints with the time-frequency resources and the orthogonal code resources.

Assuming that the available frequency resources or orthogonal code resources are reduced due to some reasons (such as resource preemption by other high-priority services) in a process of performing a sensing service or an integrated sensing and communication service in the MIMO-ISAC system, to maintain the predetermined sensing performance, one solution is to switch to the TDM+antenna selection mode for sensing. In this case, the antenna resources of the MIMO-ISAC are bound to time resources of the first signal. Still using FIG. 4 as an example, in a time period without a traffic jam, at eight different moments within a preset time, antenna pairs {A1, B2}, {A1, B3}, {A1, B5}, {A1, B6}, {A2, B2}, {A2, B3}, {A2, B5}, and {A2, B6} are selected respectively; in a time period with a traffic jam, at 18 different moments within a preset time, antenna pairs {A1, B1}, {A1, B2}, {A1, B3}, {A1, B4}, {A1, B5}, {A1, B6}, {A1, B7}, {A1, B8}, {A1, B9}, {A2, B1}, {A2, B2}, {A2, B3}, {A2, B4}, {A2, B5}, {A2, B6}, {A2, B7}, {A2, B8}, and {A2, B9} are selected respectively.

It should be noted that in the foregoing scenario, it is necessary to ensure that a status of the sensing target or the environment in the sensing area does not change significantly within the preset antenna selection time.

In some embodiments, in some embodiments, a change in the position of the sensing target or a change in the environment in the sensing area causes a low SNR or SINR, and it is necessary to change the quantity of antennas to maintain the SNR or SINR or increase the SNR or SINR.

The sensing performance of the MIMO-ISAC is not only related to the aperture of the virtual array, but also related to the SNR (SINR when considering interference) of each virtual aperture. In a case that an SNR of the received first signal is low, transmit power of the selected antenna array element can be increased most directly. However, due to a limitation of hardware (such as a limited linear range of an antenna power amplifier), it is impossible to increase the transmit power infinitely. Another method is to increase the SNR through beamforming, but in this case, the virtual aperture is reduced equivalently and the sensing resolution is reduced.

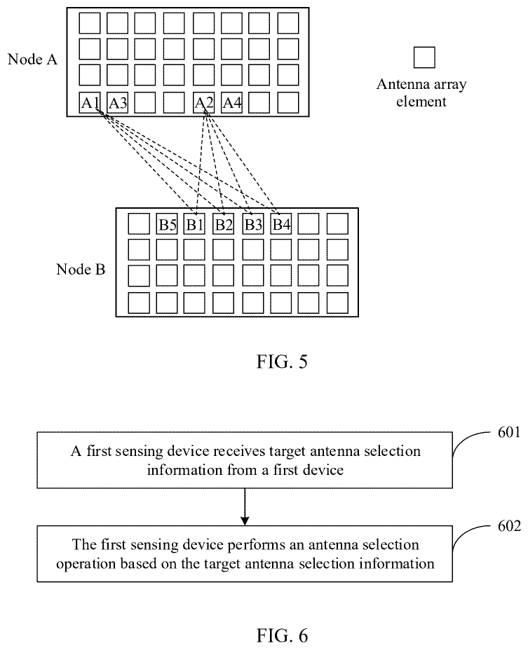

In this embodiment, a virtual array with overlapping virtual array elements is formed through the adaptive antenna selection, so that an SNR at overlapping virtual array element positions can be increased, thereby improving the sensing performance. As shown in FIG. 5, at an initial stage of a sensing service or an integrated sensing and communication service, node A selects antennas {A1, A2} to send a first signal, and node B selects antennas {B1, B2, B3, B4} to receive the first signal, thereby constructing a virtual array with eight array elements. When an SNR/SINR decreases in a time period in the service, the first device instructs node A to select antennas {A1, A2, A3, A4} to send the first signal, and node B to select antennas {B1, B2, B3, B4, B5} to receive the first signal, thereby forming a virtual array with nine array elements, and superimposing new virtual array elements on the original virtual array with eight array elements. After a sensing result computing node coherently combines channel data of the different antenna pairs, an equivalent SNR of a virtual array element is increased, and further, the sensing performance is improved. It should be noted that there may be more than one antenna selection set forming overlapping virtual array elements, featuring high flexibility.

In some embodiments, in some embodiments, in a case of limited resources, node A dynamically indicates a unitary matrix of a signal correlation matrix to node B, and node B performs antenna selection adaptation to maintain/improve the sensing performance.

As can be learned from equations (14) to (16), a first signal correlation matrix of the MIMO-ISAC affects the effective aperture of the virtual array. Because the available time-frequency resources, orthogonal code resources, and the like may be all dynamic, the first signal may also be dynamic. For example, node A is a base station and node B is a terminal. Although the terminal may calculate a unitary matrix U of the first signal correlation matrix by itself based on the received parameter configuration information of the first signal, considering a relatively weak computing capability of the terminal, the base station may dynamically send U to the terminal. The terminal performs antenna selection adaptation based on U and the received array antenna selection information and antenna array information (or steering vector) of the base station, so that a quantity of non-identical elements in equation (14) is maintained at a stable level and that the sensing performance is ensured.

As shown in FIG. 6, an embodiment of this application further provides a sensing processing method, including the following steps.

Step 601: A first sensing device receives target antenna selection information from a first device.

Step 602: The first sensing device performs an antenna selection operation based on the target antenna selection information, where an antenna selected by the antenna selection operation is used to send or receive a first signal.

In some embodiments, the target antenna selection information is determined based on target information, where the target information includes information for determining whether to update antenna selection information.

In some embodiments, the target information includes at least one of the following:
a sensing result obtained by performing a first service associated with the first signal in a preset time period;
antenna selection information for performing the first service by a target sensing device in the preset time period, where the target sensing device includes at least one of the sending device for sending the first signal and the receiving device for receiving the first signal, and the target sensing device includes the first sensing device;
antenna array information of the target sensing device;
first status information of a sensing target;
channel information;
resource information associated with the first service; and
first information for determining a sensing device.

In some embodiments, the method further includes:
the first sensing device sends second information of the first sensing device to the first device, where the second information is used to determine a target configuration parameter, and the target configuration parameter is used for at least one sensing device to perform a first service associated with the first signal.

In some embodiments, the target configuration parameter includes signal configuration information of the first signal, antenna selection information of the sending device, and antenna selection information of the receiving device.

In some embodiments, the method further includes:
the first sensing device sends second information of the first sensing device to the first device, where the second information is used to determine an initial configuration parameter of the first sensing device;
the first sensing device receives the initial configuration parameter of the first sensing device from a target device; and
the first sensing device performs, based on the initial configuration parameter of the first sensing device, a first service associated with the first signal, where
in a case that the first sensing device is the device for sending the first signal, the initial configuration parameter of the first sensing device is a first configuration parameter, and the target device is the first device; or in a case that the first sensing device is the device for receiving the first signal, the target device is the sending device, and the initial configuration parameter of the first sensing device is a second configuration parameter determined by the sending device.

In some embodiments, in the case that the first sensing device is the sending device, the method further includes:
the first sensing device receives second information from the receiving device;
the first sensing device determines a second configuration parameter of the receiving device based on the second information, where the second configuration parameter is used for the receiving device to perform the first service associated with the first signal; and the first sensing device sends the second configuration parameter to the receiving device.

In some embodiments, the first configuration parameter includes signal configuration information of the first signal and antenna selection information of the sending device.

In some embodiments, the second configuration parameter includes signal configuration information of the first signal and antenna selection information of the receiving device.

In some embodiments, the second information includes at least one of the following: antenna array information, first status information of a sensing target, channel information, resource information associated with the first service, and first information for determining a sensing device.

In some embodiments, the method further includes:
the first sensing device obtains third information; and
the first sensing device obtains a sensing result through calculation based on the third information, where
the third information includes:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and
signal configuration information of the first signal.

In some embodiments, the third information meets at least one of the following:
in a case that the sending device performs precoding, the third information further includes precoding information; or
in a case that the sending device performs beamforming, the third information further includes beamforming matrix information.

In some embodiments, that the first sensing device obtains third information includes any one of the following:
in a case that the first sensing device locally stores all of the third information, the first sensing device obtains the locally stored third information; or
in a case that the first sensing device locally stores first sub-information but does not store second sub-information, the first sensing device obtains the locally stored first sub-information, and obtains the second sub-information from at least one of the first device and at least one second sensing device, where the first sub-information is part of the third information and the second sub-information is another part of the third information.

In some embodiments, the method further includes:
the first sensing device sends fourth information to a computing device, where the fourth information is used to calculate a sensing result, the computing device is a device for calculating the sensing result, and the fourth information includes at least one of the following: antenna array information of the first sensing device;
antenna selection information of the first sensing device or a first steering vector determined based on antenna selection information of the sending device; and
signal configuration information of the first signal.

In some embodiments, in a case that the first sensing device is the sending device, the fourth information meets at least one of the following:
in a case that the first sensing device performs precoding, the fourth information further includes precoding information; or
in a case that the first sensing device performs beamforming, the fourth information further includes beamforming matrix information.

In some embodiments, after the first sensing device sends the fourth information to the computing device, the method further includes:
the first sensing device receives the sensing result from the computing device.

In some embodiments, the antenna selection information includes at least one of the following:
an identity of an antenna array element that sends the first signal;
an identity of an antenna array element that receives the first signal;
an identity of a first antenna panel that sends the first signal;
an identity of a second antenna panel that receives the first signal;
position information of the antenna array element that sends the first signal relative to a preset local reference point of an antenna array;
position information of the antenna array element that receives the first signal relative to a preset local reference point of an antenna array;
position information of the first antenna panel that sends the first signal relative to the preset local reference point of the antenna array and position information of the antenna array element for sending the first signal in the first antenna panel relative to a preset unified reference point of the first antenna panel;
position information of the second antenna panel that receives the first signal relative to the preset local reference point of the antenna array and position information of the antenna array element for receiving the first signal in the second antenna panel relative to a preset unified reference point of the second antenna panel;
bitmap information of an antenna array element; and
bitmap information of an array antenna panel.

In some embodiments, the antenna array information includes at least one of the following:
a set of first identities available for the first service associated with the first signal, where the first identities are identities of antenna array elements;
a mapping relationship between a first identity and a position of an antenna array element in an antenna array;
a mapping relationship between a second identity and a position of an antenna panel in an antenna array in a case that the antenna array includes at least two antenna panels, where the second identity is an identity of an antenna panel;
bitmap rules of antenna array elements;
bitmap rules of antenna panels and bitmap rules of antenna array elements in a single antenna panel in a case that an antenna array includes at least two antenna panels;
an antenna array type;
a quantity of antenna panels included in an antenna array;
a quantity of antenna array elements included in an antenna array;
position information of a predetermined local reference point of an antenna array;
position information of an antenna panel relative to a local reference point of an antenna array in a case that the antenna array includes at least two antenna panels;
position information of an antenna array element relative to a preset local reference point of an antenna array;
position information of an antenna array element in each antenna panel relative to a preset unified reference point of the antenna panel in a case that an antenna array includes at least two antenna panels;
a polarization mode of an antenna with the first identity; and
three-dimensional or two-dimensional pattern information of at least some antenna array elements.

In some embodiments, the first status information includes at least one of the following:
a first measurement value of a first measurement parameter of the sending device, where the first measurement parameter includes at least one of an azimuth of departure and an elevation of departure of the sensing target;
a second measurement value of a second measurement parameter of the receiving device, where the second measurement parameter includes at least one of an azimuth of arrival and an elevation of arrival of the sensing target;
a standard deviation or a variance of the first measurement values obtained in at least two sensing measurements;
a standard deviation or a variance of the second measurement values obtained in at least two sensing measurements;
a mean, a standard deviation, or a variance of at least two first values, where the first value is a difference between the first measurement value obtained in one sensing measurement and a first predictor corresponding to the first measurement parameter;
a mean, a standard deviation, or a variance of at least two second values, where the second value is a difference between the second measurement value obtained in one sensing measurement and a second predictor corresponding to the second measurement parameter; a distance from the sensing target to the sending device;
a distance from the sensing target to the receiving device;
a moving speed of the sensing target;
a moving direction of the sensing target;
a first velocity component, where the first velocity component is a magnitude of a velocity component of the sensing target, obtained in one sensing measurement, in at least one coordinate axis direction in a preset Cartesian coordinate system;
a mean, a standard deviation, or a variance of the first velocity components obtained in at least two sensing measurements;
a mean, a standard deviation, or a variance of at least two third values, where the third value is a difference between the first velocity component obtained in one sensing measurement and a third predictor corresponding to the velocity component;
position coordinates of the sensing target;
a mean, a standard deviation, or a variance of the position coordinates of the sensing target that are obtained in at least two sensing measurements;
a mean, a standard deviation, or a variance of at least two fourth values, where the fourth value is a difference between the position coordinates of the sensing target that are obtained in one sensing measurement and a fourth predictor corresponding to the position coordinates;
a third measurement value of a third measurement parameter of the first signal received on at least one antenna array element on the receiving device, where the third measurement parameter includes received power, a signal-to-noise ratio SNR, and a signal to interference plus noise ratio SINR;
a mean, a standard deviation, or a variance of at least two third measurement values; a mean, a standard deviation, or a variance of at least two fifth values, where the fifth value is a difference between the third measurement value obtained in one sensing measurement and a fifth predictor corresponding to the third measurement parameter;
a mean, a standard deviation, or a variance of the first signal received on at least two antenna array elements in an antenna array of the receiving device;
a fourth measurement value of a fourth measurement parameter of a power spectrum of the sensing target, where the fourth measurement parameter includes at least one of an average angle of the received first signal and an angle spread of the received first signal; a mean, a standard deviation, or a variance of at least two sixth values, where the sixth value is a difference between the fourth measurement value obtained in one sensing measurement and a sixth predictor corresponding to the fourth measurement parameter;
a fifth measurement value of a fifth measurement parameter of a delay power spectrum of the sensing target, where the fifth measurement parameter includes at least one of a received signal average delay of the first signal and a received signal delay spread of the first signal;
a mean, a standard deviation, or a variance of at least two seventh values, where the seventh value is a difference between the fifth measurement value obtained in one sensing measurement and a seventh predictor corresponding to the fifth measurement parameter;
a sixth measurement value of a sixth measurement parameter of a Doppler power spectrum of the sensing target, where the sixth measurement parameter includes at least one of a received signal average Doppler frequency shift of the first signal and a received signal Doppler spread of the first signal;
a mean, a standard deviation, or a variance of at least two eighth values, where the eighth value is a difference between the sixth measurement value obtained in one sensing measurement and an eighth predictor corresponding to the sixth measurement parameter; environmental clutter power;
a mean, a standard deviation, or a variance of at least two ninth values, where the ninth value is a difference between the environmental clutter power obtained in one sensing measurement and a ninth predictor corresponding to the environmental clutter power; a seventh measurement value of a seventh measurement parameter, where the seventh measurement parameter includes at least one of a Doppler bandwidth of environmental clutter and a Doppler bandwidth of superposition of the environmental clutter and the sensing target;
a mean, a standard deviation, or a variance of at least two tenth values, where the tenth value is a difference between the seventh measurement value obtained in one sensing measurement and a tenth predictor corresponding to the seventh measurement parameter; a quantity of sensing targets in a preset sensing area;
density of the sensing targets in the preset sensing area; and position coordinates of the sensing area and parameters related to a size of a physical range in a case that the sensing area changes.

In some embodiments, the channel information includes fifth information of any antenna pair between the sending device and the receiving device, and the fifth information includes at least one of the following: a channel transmission function, a channel impulse response, channel state information, a channel quality indicator, a rank indicator, and a performance indicator related to communication.

In some embodiments, the resource information includes a resource quantity of target resources available for the first service associated with the first signal, and the target resource includes at least one of the following: a time resource, a frequency resource, an antenna resource, a Doppler frequency division multiplexing DDM phase modulator resource, and an orthogonal code resource.

In some embodiments, the first information includes at least one of the following: a sensing requirement, a service type, quality of service QoS of sensing or QoS of integrated sensing and communication, prior information of a sensing area, and prior information of the sensing target.

The sensing processing method provided in the embodiments of this application may be performed by a sensing processing apparatus. A sensing processing apparatus provided in the embodiments of this application is described by assuming that the sensing processing method is performed by the sensing processing apparatus in the embodiments of this application.

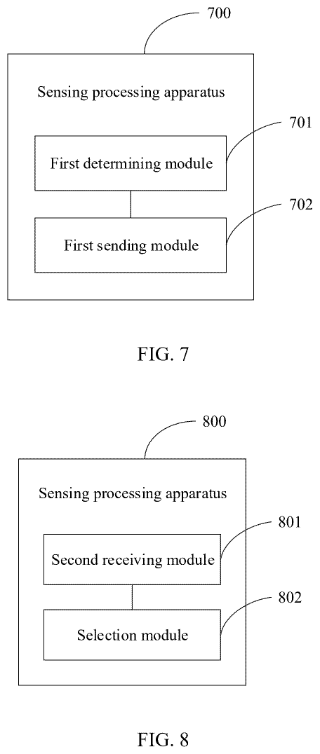

Referring to FIG. 7, an embodiment of this application further provides a sensing processing apparatus. As shown in FIG. 7, the sensing processing apparatus 700 includes:

a first determining module 701, configured to determine target antenna selection information of a target sensing device based on target information in a case that the target information changes; and a first sending module 702, configured to send the target antenna selection information, where the target sensing device includes at least one of a sending device for sending a first signal and a receiving device for receiving the first signal, and the target antenna selection information is used for the target sensing device to perform an antenna selection for the first signal.

In some embodiments, the target information includes at least one of the following: a sensing result obtained by performing a first service associated with the first signal in a preset time period;
antenna selection information for performing the first service by the target sensing device in the preset time period;
antenna array information of the target sensing device;
first status information of a sensing target;
channel information;
resource information associated with the first service; and
first information for determining a sensing device.

In some embodiments, the sensing processing apparatus 700 further includes:
a first obtaining module, configured to obtain second information of at least one sensing device, where the at least one sensing device includes the target sensing device;
a second determining module, configured to determine a target configuration parameter based on the second information, where the target configuration parameter is an initial configuration parameter; and
a first sending module, configured to send the target configuration parameter to the at least one sensing device, where the target configuration parameter is used for the at least one sensing device to perform a first service associated with the first signal.

In some embodiments, the target configuration parameter includes signal configuration information of the first signal, antenna selection information of the sending device, and antenna selection information of the receiving device.

In some embodiments, the sensing processing apparatus 700 further includes:
a first obtaining module, configured to obtain second information of at least two sensing devices, where the at least two sensing devices include the target sensing device;
a second determining module, configured to determine a first configuration parameter based on second information of the sending device of the at least two sensing devices, where the first configuration parameter is used for the sending device to perform a first service associated with the first signal, and the first configuration parameter is an initial configuration parameter; and
a first sending module, configured to send the first configuration parameter and second information of the receiving device to the sending device, where the second information of the receiving device is used to determine a second configuration parameter, the second configuration parameter is used for the receiving device of the at least two sensing devices to perform the first service, and the second configuration parameter is an initial configuration parameter.

In some embodiments, the first configuration parameter includes signal configuration information of the first signal and antenna selection information of the sending device.

In some embodiments, the second configuration parameter includes signal configuration information of the first signal and antenna selection information of the receiving device.

In some embodiments, the second information includes at least one of the following: antenna array information, first status information of a sensing target, channel information, resource information associated with the first service, and first information for determining a sensing device.

In some embodiments, the sensing processing apparatus 700 further includes:
a first obtaining module, configured to obtain third information; and
a first calculation module, configured to obtain a sensing result through calculation based on the third information, where
the third information includes:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and signal configuration information of the first signal.

In some embodiments, the third information meets at least one of the following:
in a case that the sending device performs precoding, the third information further includes precoding information; or in a case that the sending device performs beamforming, the third information further includes beamforming matrix information.

In some embodiments, the first obtaining module is further configured to perform any one of the following:

in a case that the first device locally stores all of the third information, obtaining the locally stored third information;

in a case that the first device locally stores first sub-information but does not store second sub-information, obtaining the locally stored first sub-information, and obtaining the second sub-information from at least one sensing device, where the first sub-information is part of the third information and the second sub-information is another part of the third information; or in a case that the first device locally stores all of the third information, obtaining the third information from at least one sensing device.

In some embodiments, the sensing processing apparatus 700 further includes:
a first sending module, configured to send fourth information to a computing device, where the fourth information is used to calculate a sensing result, the computing device is a device for calculating the sensing result, and the fourth information includes at least one of the following:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and
signal configuration information of the first signal.

In some embodiments, the fourth information meets at least one of the following:
in a case that the sending device performs precoding, the fourth information further includes precoding information; or
in a case that the sending device performs beamforming, the fourth information further includes beamforming matrix information.

In some embodiments, the sensing processing apparatus 700 further includes:
a first receiving module, configured to receive the sensing result from the computing device.

In some embodiments, the antenna selection information includes at least one of the following:
an identity of an antenna array element that sends the first signal;
an identity of an antenna array element that receives the first signal;
an identity of a first antenna panel that sends the first signal;
an identity of a second antenna panel that receives the first signal;
position information of the antenna array element that sends the first signal relative to a preset local reference point of an antenna array;
position information of the antenna array element that receives the first signal relative to a preset local reference point of an antenna array;
position information of the first antenna panel that sends the first signal relative to the preset local reference point of the antenna array and position information of the antenna array element for sending the first signal in the first antenna panel relative to a preset unified reference point of the first antenna panel;
position information of the second antenna panel that receives the first signal relative to the preset local reference point of the antenna array and position information of the antenna array element for receiving the first signal in the second antenna panel relative to a preset unified reference point of the second antenna panel;
bitmap information of an antenna array element; and
bitmap information of an array antenna panel.

In some embodiments, the antenna array information includes at least one of the following:
a set of first identities available for the first service associated with the first signal, where the first identities are identities of antenna array elements;
a mapping relationship between a first identity and a position of an antenna array element in an antenna array;
a mapping relationship between a second identity and a position of an antenna panel in an antenna array in a case that the antenna array includes at least two antenna panels, where the second identity is an identity of an antenna panel;
bitmap rules of antenna array elements;
bitmap rules of antenna panels and bitmap rules of antenna array elements in a single antenna panel in a case that an antenna array includes at least two antenna panels;
an antenna array type;
a quantity of antenna panels included in an antenna array;
a quantity of antenna array elements included in an antenna array;
position information of a predetermined local reference point of an antenna array;
position information of an antenna panel relative to a local reference point of an antenna array in a case that the antenna array includes at least two antenna panels;
position information of an antenna array element relative to a preset local reference point of an antenna array;
position information of an antenna array element in each antenna panel relative to a preset unified reference point of the antenna panel in a case that an antenna array includes at least two antenna panels;
a polarization mode of an antenna with the first identity; and
three-dimensional or two-dimensional pattern information of at least some antenna array elements.

In some embodiments, the first status information includes at least one of the following:
a first measurement value of a first measurement parameter of the sending device, where the first measurement parameter includes at least one of an azimuth of departure and an elevation of departure of the sensing target;
a second measurement value of a second measurement parameter of the receiving device, where the second measurement parameter includes at least one of an azimuth of arrival and an elevation of arrival of the sensing target;
a standard deviation or a variance of the first measurement values obtained in at least two sensing measurements;
a standard deviation or a variance of the second measurement values obtained in at least two sensing measurements;
a mean, a standard deviation, or a variance of at least two first values, where the first value is a difference between the first measurement value obtained in one sensing measurement and a first predictor corresponding to the first measurement parameter;
a mean, a standard deviation, or a variance of at least two second values, where the second value is a difference between the second measurement value obtained in one sensing measurement and a second predictor corresponding to the second measurement parameter;
a distance from the sensing target to the sending device;
a distance from the sensing target to the receiving device;
a moving speed of the sensing target;
a moving direction of the sensing target;
a first velocity component, where the first velocity component is a magnitude of a velocity component of the sensing target, obtained in one sensing measurement, in at least one coordinate axis direction in a preset Cartesian coordinate system;
a mean, a standard deviation, or a variance of the first velocity components obtained in at least two sensing measurements;
a mean, a standard deviation, or a variance of at least two third values, where the third value is a difference between the first velocity component obtained in one sensing measurement and a third predictor corresponding to the velocity component;
position coordinates of the sensing target;
a mean, a standard deviation, or a variance of the position coordinates of the sensing target that are obtained in at least two sensing measurements;
a mean, a standard deviation, or a variance of at least two fourth values, where the fourth value is a difference between the position coordinates of the sensing target that are obtained in one sensing measurement and a fourth predictor corresponding to the position coordinates;
a third measurement value of a third measurement parameter of the first signal received on at least one antenna array element on the receiving device, where the third measurement parameter includes received power, a signal-to-noise ratio SNR, and a signal to interference plus noise ratio SINR;
a mean, a standard deviation, or a variance of at least two third measurement values;
a mean, a standard deviation, or a variance of at least two fifth values, where the fifth value is a difference between the third measurement value obtained in one sensing measurement and a fifth predictor corresponding to the third measurement parameter;
a mean, a standard deviation, or a variance of the first signal received on at least two antenna array elements in an antenna array of the receiving device;
a fourth measurement value of a fourth measurement parameter of a power spectrum of the sensing target, where the fourth measurement parameter includes at least one of an average angle of the received first signal and an angle spread of the received first signal;
a mean, a standard deviation, or a variance of at least two sixth values, where the sixth value is a difference between the fourth measurement value obtained in one sensing measurement and a sixth predictor corresponding to the fourth measurement parameter;
a fifth measurement value of a fifth measurement parameter of a delay power spectrum of the sensing target, where the fifth measurement parameter includes at least one of a received signal average delay of the first signal and a received signal delay spread of the first signal;
a mean, a standard deviation, or a variance of at least two seventh values, where the seventh value is a difference between the fifth measurement value obtained in one sensing measurement and a seventh predictor corresponding to the fifth measurement parameter;
a sixth measurement value of a sixth measurement parameter of a Doppler power spectrum of the sensing target, where the sixth measurement parameter includes at least one of a received signal average Doppler frequency shift of the first signal and a received signal Doppler spread of the first signal;
a mean, a standard deviation, or a variance of at least two eighth values, where the eighth value is a difference between the sixth measurement value obtained in one sensing measurement and an eighth predictor corresponding to the sixth measurement parameter;
environmental clutter power;
a mean, a standard deviation, or a variance of at least two ninth values, where the ninth value is a difference between the environmental clutter power obtained in one sensing measurement and a ninth predictor corresponding to the environmental clutter power;
a seventh measurement value of a seventh measurement parameter, where the seventh measurement parameter includes at least one of a Doppler bandwidth of environmental clutter and a Doppler bandwidth of superposition of the environmental clutter and the sensing target;
a mean, a standard deviation, or a variance of at least two tenth values, where the tenth value is a difference between the seventh measurement value obtained in one sensing measurement and a tenth predictor corresponding to the seventh measurement parameter;
a quantity of sensing targets in a preset sensing area;
density of the sensing targets in the preset sensing area; and
position coordinates of the sensing area and parameters related to a size of a physical range in a case that the sensing area changes.

In some embodiments, the channel information includes fifth information of any antenna pair between the sending device and the receiving device, and the fifth information includes at least one of the following: a channel transmission function, a channel impulse response, channel state information, a channel quality indicator, a rank indicator, and a performance indicator related to communication.

In some embodiments, the resource information includes a resource quantity of target resources available for the first service associated with the first signal, and the target resource includes at least one of the following: a time resource, a frequency resource, an antenna resource, a DDM phase modulator resource, and an orthogonal code resource.

In some embodiments, the first information includes at least one of the following: a sensing requirement, a service type, quality of service QoS of sensing or QoS of integrated sensing and communication, prior information of a sensing area, and prior information of the sensing target.

Referring to FIG. 8, an embodiment of this application further provides a sensing processing apparatus. As shown in FIG. 8, the sensing processing apparatus 800 includes:
a second receiving module 801, configured to receive target antenna selection information from a first device; and
a selection module 802, configured to perform an antenna selection operation based on the target antenna selection information, where an antenna selected by the antenna selection operation is used to send or receive a first signal.

In some embodiments, the target antenna selection information is determined based on target information, where the target information includes information for determining whether to update antenna selection information.

In some embodiments, the target information includes at least one of the following: a sensing result obtained by performing a first service associated with the first signal in a preset time period;
antenna selection information for performing the first service by a target sensing device in the preset time period, where the target sensing device includes at least one of the sending device for sending the first signal and the receiving device for receiving the first signal, and the target sensing device includes the first sensing device;
antenna array information of the target sensing device;
first status information of a sensing target;
channel information;
resource information associated with the first service; and
first information for determining a sensing device.

In some embodiments, the sensing processing apparatus 800 further includes:
a second sending module, configured to send second information of the first sensing device to the first device, where the second information is used to determine a target configuration parameter, and the target configuration parameter is used for at least one sensing device to perform a first service associated with the first signal.

In some embodiments, the target configuration parameter includes signal configuration information of the first signal, antenna selection information of the sending device, and antenna selection information of the receiving device.

In some embodiments, the sensing processing apparatus 800 further includes:
a second sending module, configured to send second information of the first sensing device to the first device, where the second information is used to determine an initial configuration parameter of the first sensing device; where
the second receiving module is further configured to receive the initial configuration parameter of the first sensing device from a target device; and
an execution module, configured to perform, based on the initial configuration parameter of the first sensing device, a first service associated with the first signal, where
in a case that the first sensing device is the device for sending the first signal, the initial configuration parameter of the first sensing device is a first configuration parameter, and the target device is the first device; or in a case that the first sensing device is the device for receiving the first signal, the target device is the sending device, and the initial configuration parameter of the first sensing device is a second configuration parameter determined by the sending device.

In some embodiments, in the case that the first sensing device is the sending device, the sensing processing apparatus 800 further includes a third determining module, where
the second receiving module is further configured to receive second information from the receiving device;
the third determining module is configured to determine a second configuration parameter of the receiving device based on the second information, where the second configuration parameter is used for the receiving device to perform the first service associated with the first signal; and
the first sensing device sends the second configuration parameter to the receiving device.

In some embodiments, the first configuration parameter includes signal configuration information of the first signal and antenna selection information of the sending device.

In some embodiments, the second configuration parameter includes signal configuration information of the first signal and antenna selection information of the receiving device.

In some embodiments, the second information includes at least one of the following: antenna array information, first status information of a sensing target, channel information, resource information associated with the first service, and first information for determining a sensing device.

In some embodiments, the sensing processing apparatus further includes:
a second obtaining module, configured to obtain third information; and
a second calculation module, configured to obtain a sensing result through calculation based on the third information, where
the third information includes:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and
signal configuration information of the first signal.

In some embodiments, the third information meets at least one of the following:
in a case that the sending device performs precoding, the third information further includes precoding information; or
in a case that the sending device performs beamforming, the third information further includes beamforming matrix information.

In some embodiments, the second obtaining module is further configured to perform any one of the following:
in a case that the first sensing device locally stores all of the third information, obtaining the locally stored third information; or
in a case that the first sensing device locally stores first sub-information but does not store second sub-information, obtaining the locally stored first sub-information, and obtaining the second sub-information from at least one of the first device and at least one second sensing device, where the first sub-information is part of the third information and the second sub-information is another part of the third information.

In some embodiments, the sensing processing apparatus further includes:
a second sending module, configured to send fourth information to a computing device, where the fourth information is used to calculate a sensing result, the computing device is a device for calculating the sensing result, and the fourth information includes at least one of the following:
antenna array information of the first sensing device;
antenna selection information of the first sensing device or a first steering vector determined based on antenna selection information of the sending device; and
signal configuration information of the first signal.

In some embodiments, in a case that the first sensing device is the sending device, the fourth information meets at least one of the following:

in a case that the first sensing device performs precoding, the fourth information further includes precoding information; or in a case that the first sensing device performs beamforming, the fourth information further includes beamforming matrix information.

In some embodiments, the second receiving module is further configured to receive the sensing result from the computing device.

In some embodiments, the antenna selection information includes at least one of the following:
an identity of an antenna array element that sends the first signal;
an identity of an antenna array element that receives the first signal;
an identity of a first antenna panel that sends the first signal;
an identity of a second antenna panel that receives the first signal;
position information of the antenna array element that sends the first signal relative to a preset local reference point of an antenna array;
position information of the antenna array element that receives the first signal relative to a preset local reference point of an antenna array;
position information of the first antenna panel that sends the first signal relative to the preset local reference point of the antenna array and position information of the antenna array element for sending the first signal in the first antenna panel relative to a preset unified reference point of the first antenna panel;
position information of the second antenna panel that receives the first signal relative to the preset local reference point of the antenna array and position information of the antenna array element for receiving the first signal in the second antenna panel relative to a preset unified reference point of the second antenna panel;
bitmap information of an antenna array element; and
bitmap information of an array antenna panel.

In some embodiments, the antenna array information includes at least one of the following:
a set of first identities available for the first service associated with the first signal, where the first identities are identities of antenna array elements;
a mapping relationship between a first identity and a position of an antenna array element in an antenna array;
a mapping relationship between a second identity and a position of an antenna panel in an antenna array in a case that the antenna array includes at least two antenna panels, where the second identity is an identity of an antenna panel;
bitmap rules of antenna array elements;
bitmap rules of antenna panels and bitmap rules of antenna array elements in a single antenna panel in a case that an antenna array includes at least two antenna panels;
an antenna array type;
a quantity of antenna panels included in an antenna array;
a quantity of antenna array elements included in an antenna array;
position information of a predetermined local reference point of an antenna array;
position information of an antenna panel relative to a local reference point of an antenna array in a case that the antenna array includes at least two antenna panels;
position information of an antenna array element relative to a preset local reference point of an antenna array;
position information of an antenna array element in each antenna panel relative to a preset unified reference point of the antenna panel in a case that an antenna array includes at least two antenna panels;
a polarization mode of an antenna with the first identity; and
three-dimensional or two-dimensional pattern information of at least some antenna array elements.

In some embodiments, the first status information includes at least one of the following:
a first measurement value of a first measurement parameter of the sending device, where the first measurement parameter includes at least one of an azimuth of departure and an elevation of departure of the sensing target;
a second measurement value of a second measurement parameter of the receiving device, where the second measurement parameter includes at least one of an azimuth of arrival and an elevation of arrival of the sensing target;
a standard deviation or a variance of the first measurement values obtained in at least two sensing measurements;
a standard deviation or a variance of the second measurement values obtained in at least two sensing measurements;
a mean, a standard deviation, or a variance of at least two first values, where the first value is a difference between the first measurement value obtained in one sensing measurement and a first predictor corresponding to the first measurement parameter;
a mean, a standard deviation, or a variance of at least two second values, where the second value is a difference between the second measurement value obtained in one sensing measurement and a second predictor corresponding to the second measurement parameter;
a distance from the sensing target to the sending device;
a distance from the sensing target to the receiving device;
a moving speed of the sensing target;
a moving direction of the sensing target;
a first velocity component, where the first velocity component is a magnitude of a velocity component of the sensing target, obtained in one sensing measurement, in at least one coordinate axis direction in a preset Cartesian coordinate system;
a mean, a standard deviation, or a variance of the first velocity components obtained in at least two sensing measurements;
a mean, a standard deviation, or a variance of at least two third values, where the third value is a difference between the first velocity component obtained in one sensing measurement and a third predictor corresponding to the velocity component;
position coordinates of the sensing target;
a mean, a standard deviation, or a variance of the position coordinates of the sensing target that are obtained in at least two sensing measurements;
a mean, a standard deviation, or a variance of at least two fourth values, where the fourth value is a difference between the position coordinates of the sensing target that are obtained in one sensing measurement and a fourth predictor corresponding to the position coordinates;
a third measurement value of a third measurement parameter of the first signal received on at least one antenna array element on the receiving device, where the third measurement parameter includes received power, a signal-to-noise ratio SNR, and a signal to interference plus noise ratio SINR;
a mean, a standard deviation, or a variance of at least two third measurement values;
a mean, a standard deviation, or a variance of at least two fifth values, where the fifth value is a difference between the third measurement value obtained in one sensing measurement and a fifth predictor corresponding to the third measurement parameter;
a mean, a standard deviation, or a variance of the first signal received on at least two antenna array elements in an antenna array of the receiving device;
a fourth measurement value of a fourth measurement parameter of a power spectrum of the sensing target, where the fourth measurement parameter includes at least one of an average angle of the received first signal and an angle spread of the received first signal;
a mean, a standard deviation, or a variance of at least two sixth values, where the sixth value is a difference between the fourth measurement value obtained in one sensing measurement and a sixth predictor corresponding to the fourth measurement parameter;
a fifth measurement value of a fifth measurement parameter of a delay power spectrum of the sensing target, where the fifth measurement parameter includes at least one of a received signal average delay of the first signal and a received signal delay spread of the first
a mean, a standard deviation, or a variance of at least two seventh values, where the seventh value is a difference between the fifth measurement value obtained in one sensing measurement and a seventh predictor corresponding to the fifth measurement parameter;
a sixth measurement value of a sixth measurement parameter of a Doppler power spectrum of the sensing target, where the sixth measurement parameter includes at least one of a received signal average Doppler frequency shift of the first signal and a received signal Doppler spread of the first signal;
a mean, a standard deviation, or a variance of at least two eighth values, where the eighth value is a difference between the sixth measurement value obtained in one sensing measurement and an eighth predictor corresponding to the sixth measurement parameter;
environmental clutter power;
a mean, a standard deviation, or a variance of at least two ninth values, where the ninth value is a difference between the environmental clutter power obtained in one sensing measurement and a ninth predictor corresponding to the environmental clutter power;
a seventh measurement value of a seventh measurement parameter, where the seventh measurement parameter includes at least one of a Doppler bandwidth of environmental clutter and a Doppler bandwidth of superposition of the environmental clutter and the sensing target;
a mean, a standard deviation, or a variance of at least two tenth values, where the tenth value is a difference between the seventh measurement value obtained in one sensing measurement and a tenth predictor corresponding to the seventh measurement parameter;
a quantity of sensing targets in a preset sensing area;
density of the sensing targets in the preset sensing area; and
position coordinates of the sensing area and parameters related to a size of a physical range in a case that the sensing area changes.

In some embodiments, the channel information includes fifth information of any antenna pair between the sending device and the receiving device, and the fifth information includes at least one of the following: a channel transmission function, a channel impulse response, channel state information, a channel quality indicator, a rank indicator, and a performance indicator related to communication.

In some embodiments, the resource information includes a resource quantity of target resources available for the first service associated with the first signal, and the target resource includes at least one of the following: a time resource, a frequency resource, an antenna resource, a Doppler frequency division multiplexing DDM phase modulator resource, and an orthogonal code resource.

In some embodiments, the first information includes at least one of the following: a sensing requirement, a service type, quality of service QoS of sensing or QoS of integrated sensing and communication, prior information of a sensing area, and prior information of the sensing target.

The sensing processing apparatus in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a Network Attached Storage (NAS), and the like. This is not specifically limited in this embodiment of this application.

The sensing processing apparatus provided in this embodiment of this application can implement each process implemented in the method embodiments in FIG. 2 to FIG. 6, with the same technical effect achieved. To avoid repetition, details are not described herein again.

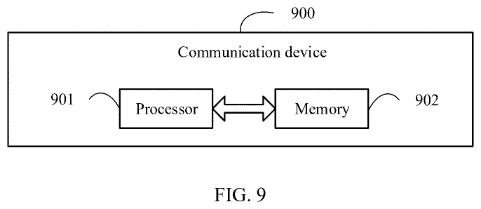

In some embodiments, as shown in FIG. 9, an embodiment of this application further provides a communication device 900, including a processor 901 and a memory 902. The memory 902 stores a program or instructions capable of running on the processor 901. When the program or instructions are executed by the processor 901, the steps of the foregoing embodiment of the sensing processing method are implemented, with the same technical effect achieved. To avoid repetition, details are not described herein again.

An embodiment of this application further provides a terminal, including a processor and a communication interface. The communication interface is configured to receive target antenna selection information from a first device. The processor is configured to perform an antenna selection operation based on the target antenna selection information, where an antenna selected by the antenna selection operation is used to send or receive a first signal. The terminal embodiment corresponds to the foregoing method embodiment on the first sensing device side, and each implementation process and implementation of the foregoing method embodiment can be applied to the terminal embodiment, with the same technical effect achieved.

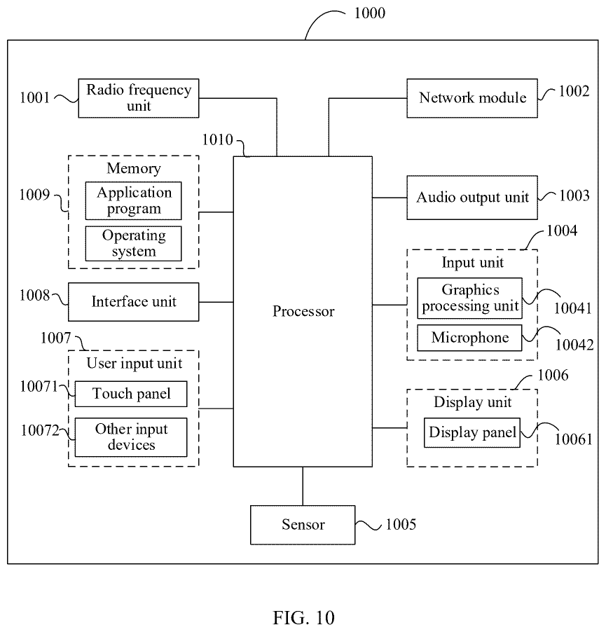

Specifically, FIG. 10 is a schematic diagram of a hardware structure of a terminal for implementing an embodiment of this application.

The terminal 1000 includes but is not limited to at least some components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (for example, a battery) supplying power to all components. The power supply may be logically connected to the processor 1010 through a power management system. In this way, functions such as charge management, discharge management, and power consumption management are implemented by using the power management system. The terminal structure shown in FIG. 10 does not constitute a limitation on the terminal. The terminal may include more or fewer components than those shown in the figure, or some components are combined, or component arrangements are different. Details are not described herein again.

It should be understood that, in this embodiment of this application, the input unit 1004 may include a Graphics Processing Unit (GPU) 10041 and a microphone 10042. The graphics processing unit 10041 processes image data of a still picture or video obtained by an image capture apparatus (such as a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and other input devices 10072. The touch panel 10071 is also referred to as a touchscreen. The touch panel 10071 may include two parts: a touch detection apparatus and a touch controller. The other input devices 10072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 1001 may transmit the downlink data to the processor 1010 for processing. In addition, the radio frequency unit 1001 may send uplink data to the network-side device. Usually, the radio frequency unit 1001 includes but is not limited to an antenna, an amplifier, a transceiver, a coupler, a low noise amplifier, a duplexer, and the like.

The memory 1009 may be configured to store software programs or instructions and various data. The memory 1009 may primarily include a first storage area for storing programs or instructions and a second storage area for storing data. The first storage area may store an operating system, an application program or instructions required by at least one function (such as an audio play function and an image play function), and the like. In addition, the memory 1009 may include a volatile memory or a non-volatile memory, or the memory 1009 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 1009 in this embodiment of this application includes but is not limited to these and any other suitable types of memories.

The processor 1010 may include one or more processing units. In some embodiments, the processor 1010 integrates an application processor and a modem processor.

The application processor mainly processes operations related to the operating system, a user interface, an application program, and the like. The modem processor mainly processes a wireless communication signal. For example, the modem processor is a baseband processor. It may be understood that the modem processor may, for example, be not integrated in the processor 1010.

The radio frequency unit 1001 is configured to receive target antenna selection information from a first device. The processor 1010 is configured to perform an antenna selection operation based on the target antenna selection information, where an antenna selected by the antenna selection operation is used to send or receive a first signal.

In this embodiment of this application, because target antenna selection information of a target sensing device is determined based on target information, antenna selection information of the target sensing device can be updated based on a current sensing environment, and further, sensing performance can be effectively improved.

An embodiment of this application further provides a network-side device, including a processor and a communication interface. The processor is configured to determine target antenna selection information of a target sensing device based on target information in a case that the target information changes; and the communication interface is configured to send the target antenna selection information, where the target sensing device includes at least one of a sending device for sending a first signal and a receiving device for receiving the first signal, and the target antenna selection information is used for the target sensing device to perform an antenna selection for the first signal. Alternatively, the communication interface is configured to receive target antenna selection information from a first device; and the processor is configured to perform an antenna selection operation based on the target antenna selection information, where an antenna selected by the antenna selection operation is used to send or receive a first signal. The network-side device embodiment corresponds to the foregoing method embodiment, and each implementation process and implementation of the foregoing method embodiment can be applied to the network-side device embodiment, with the same technical effect achieved.

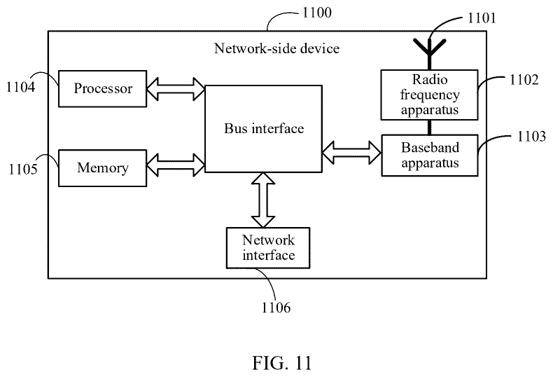

Specifically, an embodiment of this application further provides a network-side device. As shown in FIG. 11, the network-side device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes to-be-sent information, and sends the information to the radio frequency apparatus 1102; and the radio frequency apparatus 1102 processes the received information and then sends the information out by using the antenna 1101.

The method performed by the network-side device in the foregoing embodiment may be implemented in the baseband apparatus 1103. The baseband apparatus 1103 includes a baseband processor.

The baseband apparatus 1103 may include, for example, at least one baseband unit, where a plurality of chips are disposed on the baseband unit. As shown in FIG. 11, one of the chips is, for example, the baseband processor, connected to the memory 1105 by using a bus interface, to invoke a program in the memory 1105 to perform the operation of the network-side device shown in the foregoing method embodiment.

The network-side device may further include a network interface 1106, where the interface is, for example, a Common Public Radio Interface (CPRI).

Specifically, the network-side device 1100 in this embodiment of this application further includes a program or instructions stored in the memory 1105 and capable of running on the processor 1104. When the processor 1104 invokes the program or instructions in the memory 1105, the method performed by each module shown in FIG. 7 or FIG. 8 is performed, with the same technical effect achieved. To avoid repetition, details are not described herein again.

An embodiment of this application further provides a readable storage medium. The readable storage medium stores a program or instructions. When the program or instructions are executed by a processor, each process of the foregoing embodiment of the sensing processing method is implemented, with the same technical effect achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the sensing processing method, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing embodiment of the sensing processing method, with the same technical effect achieved. To avoid repetition, details are not described herein again.

An embodiment of this application further provides a communication system, including a first sensing device and a first device. The first sensing device is configured to perform each process shown in FIG. 2 and the foregoing method embodiments. The first device is configured to perform each process in FIG. 6 and the foregoing method embodiments, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and may, for example, be implemented by using hardware. However, in most cases, the former is a preferred implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A sensing processing method, comprising:
when target information changes, determining, by a first device, target antenna selection information of a target sensing device based on the target information; and
sending, by the first device, the target antenna selection information,
wherein the target sensing device comprises at least one of a sending device for sending a first signal or a receiving device for receiving the first signal, and the target antenna selection information is used for the target sensing device to perform an antenna selection for the first signal.

2. The method according to claim 1, further comprising:
obtaining, by the first device, second information of at least one sensing device, wherein the at least one sensing device comprises the target sensing device;
determining, by the first device, a target configuration parameter based on the second information, wherein the target configuration parameter is an initial configuration parameter; and
sending, by the first device, the target configuration parameter to the at least one sensing device, wherein the target configuration parameter is used for the at least one sensing device to perform a first service associated with the first signal.

3. The method according to claim 2, wherein the target configuration parameter comprises signal configuration information of the first signal, antenna selection information of the sending device, and antenna selection information of the receiving device.

4. The method according to claim 1, further comprising:
obtaining, by the first device, second information of at least two sensing devices, wherein the at least two sensing devices comprise the target sensing device;
determining, by the first device, a first configuration parameter based on second information of the sending device of the at least two sensing devices, wherein the first configuration parameter is used for the sending device to perform a first service associated with the first signal; and
sending, by the first device, the first configuration parameter and second information of the receiving device to the sending device, wherein the second information of the receiving device is used to determine a second configuration parameter, and the second configuration parameter is used for the receiving device of the at least two sensing devices to perform the first service.

5. The method according to claim 4, wherein the first configuration parameter comprises signal configuration information of the first signal and antenna selection information of the sending device.

6. The method according to claim 4, wherein the second configuration parameter comprises signal configuration information of the first signal and antenna selection information of the receiving device.

7. The method according to claim 1, further comprising:
obtaining, by the first device, third information; and
obtaining, by the first device, a sensing result through calculation based on the third information, wherein
the third information comprises:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and
signal configuration information of the first signal.

8. The method according to claim 1, further comprising:
sending, by the first device, fourth information to a computing device, wherein the fourth information is used to calculate a sensing result, the computing device is a device for calculating the sensing result, and the fourth information comprises at least one of the following:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; or
signal configuration information of the first signal.

9. The method according to claim 8, wherein the fourth information meets at least one of the following:
when the sending device performs precoding, the fourth information further comprises precoding information; or
when the sending device performs beamforming, the fourth information further comprises beamforming matrix information.

10. The method according to claim 1, wherein the target information comprises at least one of the following:
a sensing result obtained by performing a first service associated with the first signal in a preset time period;
antenna selection information for performing the first service by the target sensing device in the preset time period;
antenna array information of the target sensing device;
first status information of a sensing target;
channel information;
resource information associated with the first service; or
first information for determining a sensing device.

11. A sensing processing method, comprising:
receiving, by a first sensing device, target antenna selection information from a first device; and
performing, by the first sensing device, an antenna selection operation based on the target antenna selection information, wherein an antenna selected by the antenna selection operation is used to send or receive a first signal.

12. The method according to claim 11, further comprising:
sending, by the first sensing device, second information of the first sensing device to the first device, wherein the second information is used to determine a target configuration parameter, and the target configuration parameter is used for at least one sensing device to perform a first service associated with the first signal.

13. The method according to claim 12, wherein the target configuration parameter comprises signal configuration information of the first signal, antenna selection information of the sending device, and antenna selection information of the receiving device.

14. The method according to claim 11, further comprising:
sending, by the first sensing device, second information of the first sensing device to the first device, wherein the second information is used to determine an initial configuration parameter of the first sensing device;
receiving, by the first sensing device, the initial configuration parameter of the first sensing device from a target device; and
performing, by the first sensing device, a first service associated with the first signal based on the initial configuration parameter of the first sensing device,
wherein, when the first sensing device is a sending device of the first signal, the initial configuration parameter of the first sensing device is a first configuration parameter, and the target device is the first device; or when the first sensing device is a receiving device of the first signal, the target device is the sending device, and the initial configuration parameter of the first sensing device is a second configuration parameter determined by the sending device.

15. The method according to claim 14, wherein when the first sensing device is the sending device, the method further comprises:
receiving, by the first sensing device, second information from the receiving device;
determining, by the first sensing device, a second configuration parameter of the receiving device based on the second information, wherein the second configuration parameter is used for the receiving device to perform the first service associated with the first signal; and
sending, by the first sensing device, the second configuration parameter to the receiving device.

16. The method according to claim 12, wherein the second information comprises at least one of the following: antenna array information, first status information of a sensing target, channel information, resource information associated with the first service, or first information for determining a sensing device.

17. The method according to claim 11, further comprising:
obtaining, by the first sensing device, third information; and
obtaining, by the first sensing device, a sensing result through calculation based on the third information,
wherein, the third information comprises:
antenna array information of the sending device;
antenna selection information of the sending device or a first steering vector determined based on antenna selection information of the sending device;
antenna array information of the receiving device;
antenna selection information of the receiving device or a second steering vector determined based on antenna selection information of the receiving device; and
signal configuration information of the first signal.

18. The method according to claim 11, further comprising:
sending, by the first sensing device, fourth information to a computing device, wherein the fourth information is used to calculate a sensing result, the computing device is a device used for calculating the sensing result, and the fourth information comprises at least one of the following:
antenna array information of the first sensing device;
antenna selection information of the first sensing device or a first steering vector determined based on antenna selection information of the sending device; or
signal configuration information of the first signal.

19. The method according to claim 18, wherein when the first sensing device is the sending device, the fourth information meets at least one of the following:
when the first sensing device performs precoding, the fourth information further comprises precoding information; or
when the first sensing device performs beamforming, the fourth information further comprises beamforming matrix information.

20. A network-side device, comprising a processor and a memory storing instructions, wherein the instructions, when executed by the processor, cause the processor to perform operations comprising:
when target information changes, determining target antenna selection information of a target sensing device based on the target information; and
sending the target antenna selection information,
wherein the target sensing device comprises at least one of a sending device for sending a first signal or a receiving device for receiving the first signal, and the target antenna selection information is used for the target sensing device to perform an antenna selection for the first signal.
